(19) United States
(12) Patent Application Publication
(10) Pub. No.: US 2017/0359776 A1
(43) Pub. Date: Dec. 14, 2017

(54) WIRELESS COMMUNICATION DEVICE WHICH REDUCE POWER CONSUMPTION

(71) Applicant: KONICA MINOLTA, INC., Tokyo (JP)

(72) Inventor: Kenji MATSUHARA, Kawanishi-shi (JP)

(73) Assignee: KONICA MINOLTA, INC., Tokyo (JP)

(21) Appl. No.: 15/621,707

(22) Filed: Jun. 13, 2017

(30) Foreign Application Priority Data
Jun. 14, 2016 (JP) 2016-117979

(51) Int. Cl. H04W 52/02; H04W 48/12

(52) U.S. Cl. CPC H04W 52/0206; H04W 48/12; H04W 52/0203; H04W 52/02

(57) ABSTRACT

An MFP (Multifunction Peripheral) is a wireless communication device executes direct wireless communication with a plurality of portable terminal devices without intermediary equipment. MFP is equipped with a wireless communication unit to emit radio waves for the direct wireless communication. When starting direct wireless communication with a new portable terminal device, it is determined that the new portable terminal device satisfies a specified condition or not. When the specified condition is satisfied, the new portable terminal device is regarded as a communication maintenance target. MFP 100 weakens the intensity of radio waves which the wireless communication unit emits, so that the intensity of radio waves the wireless communication unit emits and the portable terminal device which is the communication maintenance target receives is within a predetermined range in which the direct wireless communication can be maintained. The power consumption can be reduced.

The present U.S. patent application claims a priority under the Paris Convention of Japanese patent application No. 2016-117979 filed on Jun. 14, 2016, the entirety of which is incorporated herein by references.

### BACKGROUND OF THE INVENTION

### Field of the Invention

This invention relates to a wireless communication device and a control program for a wireless communication device. More specifically, this invention relates to a wireless communication device and a control program for a wireless communication device which can reduce the power consumption.

### Description of the Related Art

There are an MFP (Multi Function Peripheral) having a scanner function, a facsimile function, a copying function, a function of a printer, a data transmitting function and a server function, a facsimile device, a copying machine, a printer, and so on, as electrophotography image forming apparatuses.

Recently, as wireless communication techniques, techniques of the Wifi direct, the beam forming, and so on are spreading. The Wifi direct is one of standards in which direct wireless communication between equipments is performed without going through a relay device such as an access point, a rooter, or the like. The beam forming is a technique to improve communication efficiency, by emitting radio waves of which the phases are optimized with locally strong intensity to a direction in which a receiving side equipment exists from a transmitting side equipment.

Conventional techniques which relate to wireless communication are disclosed in the below Documents 1 to 3, for example.

The below Document 1 discloses a technique to acquire lowest transmitting electric power of a communication terminal which establishes a connection with a wireless network access point, and adjust and determine transmitting electric power of the communication terminal according to the lowest transmitting electric power. The lowest transmitting electric power is minimum transmitting electric power which can ensure connection and communication between the communication terminal and the wireless network access point.

The below Document 2 discloses a portable terminal device which determines whether the location of the portable terminal device is within an available area, based on the location information of the portable terminal device. As for executing a function for which usage restriction was configured, when it is determined that the location is within the available area, this portable terminal device cancels the usage restriction regardless of the authentication.

The below Document 3 discloses a wireless authentication system comprising a carrier generating unit for generating a carrier wave, a modulation signal generating unit for modulating the carrier wave generated by the carrier generating unit, a duty ratio variable unit for varying the duty of the modulation signal output from the modulation signal generating unit, and an amplifier unit for amplifying the modulation signal having the duty configurated by the duty ratio variable unit and driving an LF antenna by the amplificated electrical voltage pulse.

### PRIOR ART DOCUMENT(S)

### Document(s) Related to Patent(s)

[Document 1] Japanese Translation of PCT International Application Publication No. 2013-535906

[Document 2] Japan Patent Publication No. 2012-085121

[Document 3] Japan Patent Publication No. 2008-219509

Conventionally, when an MFP not having the beam forming function performs wireless communication with a portable terminal device by the Wifi direct, the MFP emits radio waves for the wireless communication with constant intensity. Therefore, waste of power consumption occurs, when a portable terminal device which is going to be more likely to perform wireless communication with the MFP does not exist near the MFP, or the intensity of radio waves that a portable terminal device as a target of the wireless communication receives from the MFP is adequately high.

Conventionally, when an MFP having the beam forming function performs wireless communication with a portable terminal device by the Wifi direct, the MFP unconditionally performs the beam forming to all portable terminal devices which exist near the MFP. Therefore, waste of power consumption occurs, when the possibility of wireless communication of the portable terminal devices which exist near the MFP with the MFP is low, or the intensity of radio waves that a portable terminal device as a target of wireless communication receives from the MFP is already high adequately.

### SUMMARY OF THE INVENTION

This invention is to solve the above problems. The object is to provide a wireless communication device which can reduce the power consumption and a control program for the wireless communication device.

To achieve at least one of the abovementioned objects, according to an aspect, a wireless communication device capable of executing direct wireless communication with each of a plurality of communication apparatuses, without intermediary equipment, reflecting one aspect of the present invention comprise: an emitting device to emit radio waves for the direct wireless communication, a determination unit to determine whether a new communication apparatus which is one of the plurality of the communication apparatuses satisfies a specified condition or not, when the direct wireless communication starts with the new communication apparatus, a target determination unit to regard the new communication apparatus as a communication maintenance target, when the determination unit determined that the new communication apparatus satisfies the specified condition, and an adjustment unit to weaken intensity of radio waves which the emitting device emits, so that the intensity of radio waves which the emitting device emits and a communication apparatus which is the communication maintenance target receives is within a predetermined range in which the direct wireless communication can be maintained.

According to another aspect for a non-transitory computer-readable recording medium storing a controlling program for a wireless communication device capable of executing direct wireless communication with each of a plurality of communication apparatuses, without intermediary equipment, reflecting one aspect of the present invention, the wireless communication device comprises an emitting device to emit radio waves for the direct wireless communication, and the controlling program causes a computer to execute the steps to: determine whether a new communication apparatus which is one of the plurality of the communication apparatuses satisfies a specified condition or not, when the direct wireless communication starts with the new communication apparatus, regard the new communication apparatus as a communication maintenance target, when the determination step determined that the new communication apparatus satisfies the specified condition, and weaken the intensity of radio waves the emitting device emits, so that an intensity of radio waves the emitting device emits and a communication apparatus which is the communication maintenance target receives is within a predetermined range in which the direct wireless communication can be maintained.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 roughly shows a structure of an image forming system according to the first embodiment of this invention.

FIG. 2 shows a block diagram indicating a structure of MFP 100, according to the first embodiment of this invention.

FIG. 3 shows a block diagram indicating a structure of a portable terminal device 200, according to the first embodiment of this invention.

FIG. 4 shows a block diagram indicating a structure of a server 300, according to the first embodiment of this invention.

FIG. 5 shows an example of a user information table 121 stored in storage device 104 of MFP 100, according to the first embodiment of this invention.

FIG. 6 shows the first figure indicating the behavior of MFP 100, according to the first embodiment of this invention.

FIG. 7 shows the second figure indicating the behavior of MFP 100, according to the first embodiment of this invention.

FIG. 8 shows an example of the adjustment method for the intensity of radio waves emitted from wireless communication unit 122, according to the first embodiment of this invention.

FIG. 9 shows the third figure indicating the behavior of MFP 100, according to the first embodiment of this invention.

FIG. 10 shows the fourth figure indicating the behavior of MFP 100, according to the first embodiment of this invention.

FIG. 11 shows the fifth figure indicating the behavior of MFP 100, according to the first embodiment of this invention.

FIG. 12 schematically shows a screen for receiving configurations of a connection area displayed on a display unit DP in an operation panel 108, according to the first embodiment of this invention.

FIG. 13 shows the first part of a flowchart indicating the behavior of MFP 100, according to the first embodiment of this invention.

FIG. 14 shows the second part of a flowchart indicating the behavior of MFP 100, according to the first embodiment of this invention.

FIG. 15 shows a subroutine of the communication maintenance target determining process (S115) in FIG. 13.

FIG. 16 shows an example of entering/leaving room table 321 stored in storage device 304 of the server 300, according to the second embodiment of this invention.

FIG. 17 shows the first figure indicating the behavior of MFP 100, according to the second embodiment of this invention.

FIG. 18 shows the second figure indicating the behavior of MFP 100, according to the second embodiment of this invention.

FIG. 19 shows the third figure indicating the behavior of MFP 100, according to the second embodiment of this invention.

FIG. 20 shows the first part of a flowchart indicating the behavior of MFP 100, according to the second embodiment of this invention.

FIG. 21 shows the second part of a flowchart indicating the behavior of MFP 100, according to the second embodiment of this invention.

FIG. 22 shows the first figure indicating the behavior of MFP 100, according to the third embodiment of this invention.

FIG. 23 shows an example of the adjustment method of the intensity of radio waves emitted from wireless communication unit 122, according to the third embodiment of this invention.

FIG. 24 shows the second figure indicating the behavior of MFP 100, according to the third embodiment of this invention.

FIG. 25 shows the third figure indicating the behavior of MFP 100, according to the third embodiment of this invention.

FIG. 26 shows the first part of a flowchart indicating the behavior of MFP 100, according to the third embodiment of this invention.

FIG. 27 shows the second part of a flowchart indicating the behavior of MFP 100, according to the third embodiment of this invention.

FIG. 28 shows the first figure indicating the behavior of MFP 100, according to the fourth embodiment of this invention.

FIG. 29 shows the second figure indicating the behavior of MFP 100, according to the fourth embodiment of this invention.

FIG. 30 shows the third figure indicating the behavior of MFP 100, according to the fourth embodiment of this invention.

FIG. 31 shows the first half part of a flowchart indicating the behavior of MFP 100, according to the fourth embodiment of this invention.

FIG. 32 shows the latter half part of a flowchart indicating the behavior of MFP 100, according to the fourth embodiment of this invention.

### DESCRIPTION OF THE PREFERRED EMBODIMENTS

Hereinafter, an embodiment of the present invention will be described with reference to the drawings. However, the scope of the invention is not limited to the illustrated examples.

In the following embodiments, a wireless communication device as an MFP will be explained. A wireless communication device may be an image forming apparatus such as a facsimile device, a copying machine, or a printer, other than an MFP. A wireless communication device may be any device as long as the wireless communication device can execute the direct wireless communication with a plurality of portable terminal devices without intermediary equipment. A wireless communication device may be a PC (Personal Computer), a mobile terminal, a home electrical appliance, or the like.

### The First Embodiment

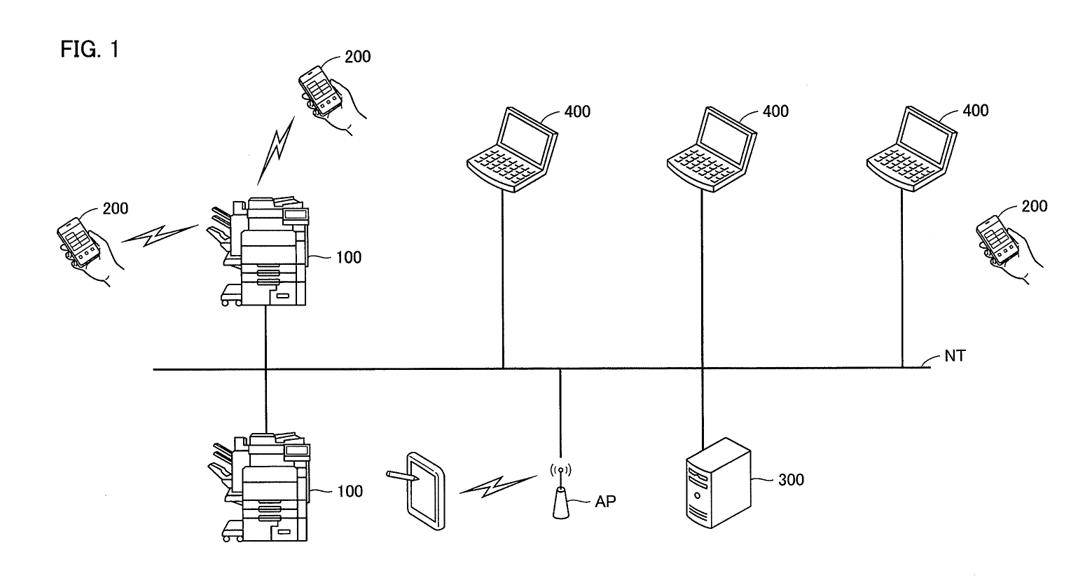

FIG. 1 roughly shows a structure of an image forming system according to the first embodiment of this invention.

Referring to FIG. 1, an image forming system according to the embodiment is equipped with a plurality of MFPs 100 (examples of a plurality of wireless communication devices), a plurality of portable terminal devices 200 (examples of a plurality of communication apparatuses), a server 300, and a plurality of PCs 400. The plurality of MFPs 100, the plurality of portable terminal devices 200, the server 300, and the plurality of PCs 400 are connected with each other via network NT, to perform bilaterally communication.

Network NT uses a private line such as a wired or wireless LAN (Local Area Network), for example. Network NT connects various equipment by using the protocol of TCP/IP (Transmission Control Protocol/Internet Protocol). The equipment connected to network NT can transmit and receive various data with each other. An access point AP is provided in network NT. When two devices connected to the network perform wireless communication, these devices can execute wireless communication via the access point AP. The image forming system may comprise equipments connected to the network NT, other than the above mentioned equipments.

In addition to the above mentioned communication via network NT, each of the plurality of MFPs 100 and each of the plurality of portable terminal devices 200 can execute the direct wireless communication bilaterally, without an intermediary equipment such as the access point AP, by using the Wifi direct standard or the like.

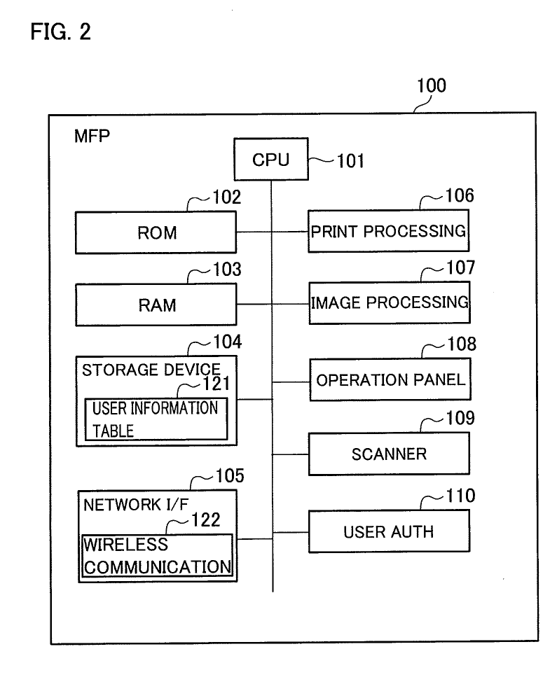

FIG. 2 shows a block diagram indicating a structure of MFP 100, according to the first embodiment of this invention.

Referring to FIG. 2, MFP 100 includes CPU (Central Processing Unit) 101, ROM (Read Only Memory) 102, RAM (Random Access Memory) 103, storage device 104, network I/F 105, print processing unit 106, image processing unit 107, operation panel 108, scanner unit 109, user authentication unit 110, and so on. ROM 102, RAM 103, storage device 104, network I/F 105, print processing unit 106, image processing unit 107, operation panel 108, scanner unit 109, and user authentication unit 110 are connected to CPU 101 via the bus.

CPU 101 controls the entire MFP 100 for various jobs such as a scan job, a copy job, a mail transmitting job, and a print job, for example. CPU 101 executes control programs stored in ROM 102.

ROM 102 is a flash ROM, for example. ROM 102 stores various programs and various fixed data to perform the behavior of MFP 100. ROM 102 may not be rewritable.

RAM 103 is a main memory for CPU 101. RAM 103 is used to temporarily store data required when CPU 101 executes a control program and image data. RAM 103 temporarily store the configuration accepted from a user for a job to be executed by MFP 100.

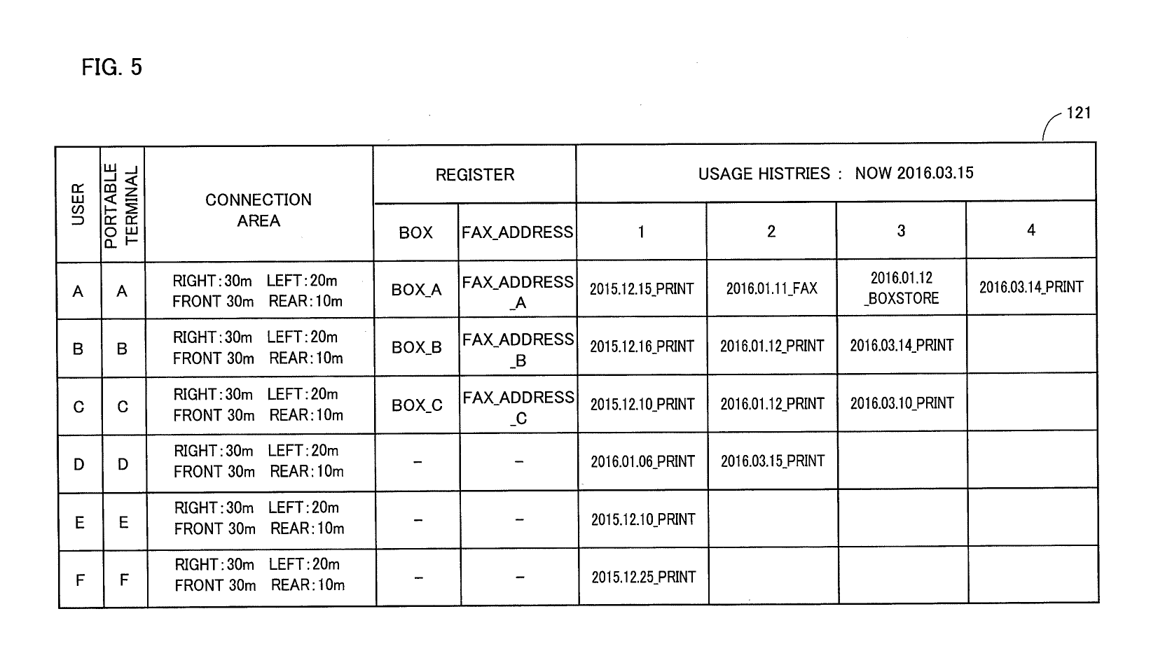

Storage device 104 is equipped with a HDD (Hard Disk Drive), for example, to store user information table 121 (FIG. 5), the location information where the MFP is installed, various data for the behavior of MFP 100, and so on.

Network I/F 105 performs communication with equipments connected to the network NT by the communications protocol such as TCP/IP, in accordance with instructions from CPU 101. Network I/F 105 includes wireless communication unit 122 (an example of an emitting device). Wireless communication unit 122 executes the direct wireless communication with portable terminal devices 200. Wireless communication unit 122 emits radio waves for the direct wireless communication, and receives radio waves transmitted from portable terminal devices 200 for the direct wireless communication.

Unless otherwise mentioned, it is supposed that wireless communication unit 122 has the beam forming function to locally emit radio waves with strong intensity toward the direction in which a specified portable terminal device 200 exists.

Print processing unit 106 executes print processes to form images on sheets or the like, based on image data processed by images processing unit 107, in accordance with an instruction of performing a printing job received from any one of the plurality of portable terminal devices.

Images processing unit 107 executes the RIP (Raster image processing) process with respect to printing data, in accordance with an instruction of performing a printing job received from any one of the plurality of portable terminal devices, the converting process to convert the data format when transmitting data to the outside, and so on.

Operation panel 108 includes a display unit which consists of a touch panel display and so on, an inputting portion which consists of hardware keys, software keys displayed on the touch panel display, and so on. Operation panel 108 receives the configuration which relates to a job to be executed by MFP 100, from a user. Operation panel 108 displays various configuration items which relate to MFP 100, messages, and so on, to a user. Operation panel 108 may have the NFC (Near Field Radio Communication) function.

Scanner unit 109 reads document images.

User authentication unit 110 authenticates the user based on a user ID stored in an ID (Identification) card possessed by each of the users, a user ID and a password input from operation panel 108 or portable terminal device 200, the IP address of the portable terminal device 200, or the like, to allow the user authenticated to use MFP 100.

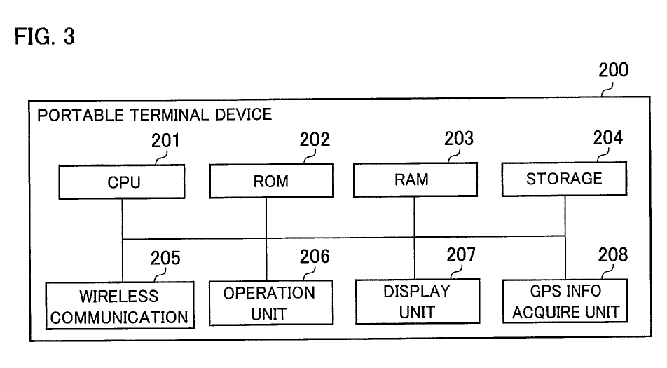

FIG. 3 shows a block diagram indicating a structure of a portable terminal device 200, according to the first embodiment of this invention.

Referring to FIG. 3, a portable terminal device 200 includes CPU 201, ROM 202, RAM 203, storage device 204, wireless communication unit 205, operation unit 206, display unit 207, and GPS (Global Positioning System) information acquire unit 208. Each of ROM 202, RAM 203, storage device 204, wireless communication unit 205, operation unit 206, display unit 207 and GPS information acquire unit 208 is connected to CPU 201 via the bus.

CPU 201 controls the entire portable terminal device 200. CPU 201 executes control programs stored in ROM 202.

ROM 202 is a flash ROM, for example. ROM 202 stores various programs and so on, to perform the behavior of portable terminal device 200.

RAM 203 is a main memory for CPU 201. RAM 203 is used to temporarily store data required when CPU 201 executes the control programs.

Storage device 204 comprises a HDD, for example, to store various data.

Wireless communication unit 205 executes the direct wireless communication with MFP 100. Wireless communication unit 205 emits radio waves for the direct wireless communication, and receives radio waves transmitted from MFP 100 for the direct wireless communication.

Operation unit 206 receives various instructions which relate to portable terminal device 200, from a user.

Display unit 207 displays various information which relates to portable terminal device 200.

GPS information acquire unit 208 acquires information (the location information) indicating the location of portable terminal device 200 by using the GPS system.

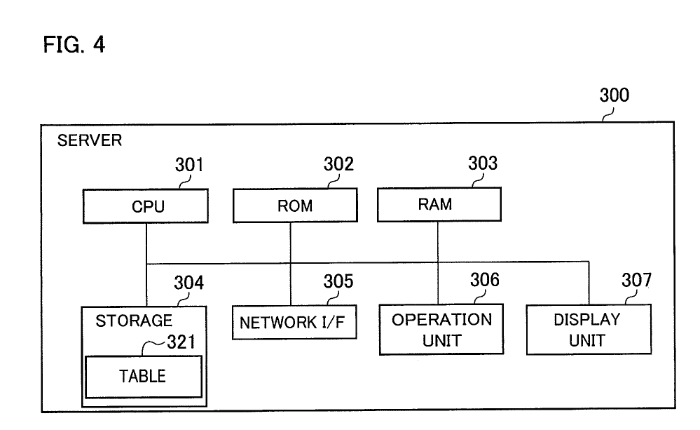

FIG. 4 shows a block diagram indicating a structure of a server 300, according to the first embodiment of this invention.

Referring to FIG. 4, server 300 executes the administration of entering/leaving room, for a room in which MFP 100 is installed. Server 300 includes CPU 301, ROM 302, RAM 303, storage device 304, network I/F 305, operation unit 306, display unit 307, and so on. Each of ROM 302, RAM 303, storage device 304, network I/F 305, operation unit 306 and display unit 307 is connected to CPU 301 via the bus.

CPU 301 controls the entire server 300. CPU 301 executes control programs stored in ROM 302.

ROM 302 is a flash ROM, for example. ROM 302 stores various programs to perform the behavior of server 300, and various fixed data. ROM 302 may not be rewritable.

RAM 303 is a main memory for CPU 301. RAM 303 is used to temporarily store data required when CPU 301 executes control programs, image data, and so on. RAM 303 may have a cache memory area for CPU 301.

Storage device 304 comprises a HDD, for example, to store various data for the behavior of server 300 such as entering/leaving room table 321 and so on.

Network I/F 305 performs communication with MFP 100 via network NT, by communications protocol such as the TCP/IP, in accordance with instructions from CPU 301.

Operation unit 306 receives various instructions which relate to server 300, from a user.

Display unit 307 displays various information which relates to server 300.

FIG. 5 shows an example of a user information table 121 stored in storage device 104 of MFP 100, according to the first embodiment of this invention.

Referring to FIG. 5, user information table 121 is a table on which information related to users of MFP 100 is recorded. The user information table includes items in which users are recorded, items in which portable terminal devices possessed by the users are recorded, items in which connection areas (examples of predetermined communication ranges) of portable terminal devices possessed by the users are recorded, items in which storing areas (boxes) associated with the users in storage device 104 are recorded, items in which facsimile transmitting addresses of the users are recorded, and items in which the usage histories for jobs on MFP 100 executed by the users via the portable terminal devices are recorded. As the usage histories, up to four histories are recorded from the new one.

According to user information table 121, for example, the “user A” has the portable terminal device named “portable terminal device A” and the storing area named “BOX_A” in storage device 104, and the facsimile transmitting address of “FAX_address A” is recorded in storage device 104. The “user A” has 4 histories, wherein the newest usage history is for a print job executed on “Mar. 14, 2016”.

The user A, the user B, and the user C have storing areas in storage device 104, and the facsimile transmitting addresses are recorded in storage device 104. On the other hand, the user D, the user E, and the user F do not have storing areas in storage device 104, the facsimile transmitting addresses are not recorded in storage device 104. Unless otherwise noted, for all the portable terminal devices of the users, it is supposed that the same connection area of “30 m to the right, 20 m to the left, 30 m to the front side, 10 m to the back side” using the location at which MFP 100 is installed as a reference is configured.

User information table 121 may further include items in which the mail addresses of users are recorded. The information such as portable terminal devices, connection areas, boxes, facsimile transmitting addresses, and mail addresses are beforehand registered by users, an administrator of MFP 100, or the like. The usage histories of MFP 100 are updated by CPU 101 at the timing of the job execution.

User information table 121 may be recorded in storage device 304 of server 300.

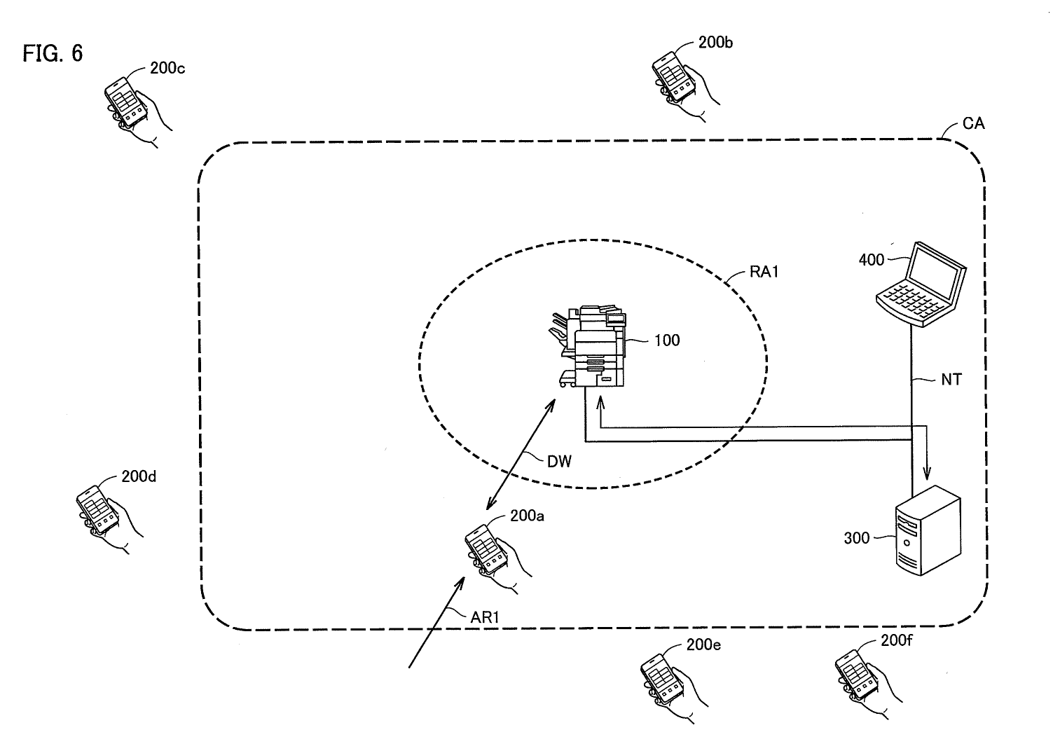

Next, the behavior of MFP 100 according to the embodiment will be explained by using FIGS. 6 to 11.

When MFP 100 begins to perform the direct wireless communication with a new portable terminal device which is one of the plurality of portable terminal devices, MFP 100 determines whether the new portable terminal device satisfies a specified condition or not. When the new portable terminal device satisfies the specified condition, MFP 100 regards the new portable terminal device as a communication maintenance target. MFP 100 weakens the intensity of radio waves which wireless communication unit 122 emits, so that the intensity of radio waves received by the portable terminal device as the communication maintenance target, which is radio waves emitted from wireless communication unit 122 is within a predetermined range in which the direct wireless communication can be maintained.

The following explanation is for the behavior of one specified MFP 100 among the plurality of MFPs 100 in the image forming system shown by FIG. 1. Each of the plurality of MFPs 100 in the image forming system shown by FIG. 1 performs the behavior similar to the following explanation.

In the following explanations, portable terminal devices 200a, 200b, 200c, 200d, 200e and 200f correspond respectively to “portable terminal device A”, “portable terminal device B”, “portable terminal device C”, “portable terminal device D”, “portable terminal device E”, and “portable terminal device F” in user information table 121 shown in FIG. 5.

In FIGS. 6, 7, 9 to 11, 17 to 19, 22, 24, 25, and 28 to 30, parts of equipments which constitute the image forming system of FIG. 1 are shown.

Each of ranges RA1, RA2, RA3, RA4, RA11, RA12, RA21, RA22, RA23, RA31, and RA32 conceptually shows a range in which the communication is uninterrupted. As for the ranges, the radio waves attenuation due to the presence of obstacles or the like is not considered. Hence, the ranges are different from actual ranges.

FIG. 6 shows the first figure indicating the behavior of MFP 100, according to the first embodiment of this invention.

Referring to FIG. 6, user A carrying the portable terminal device 200a approaches MFP 100 as shown by arrow AR1, and each of MFP 100 and portable terminal device 200a is ready for communicating. MFP 100 begins to perform the direct wireless communication DW with portable terminal device 200a. MFP 100 acquires necessary information from portable terminal device 200a, and executes processes of the authentication for user A based on the acquired information.

At the time point when MFP 100 and portable terminal device 200a start the direct wireless communication DW, the MFP 100 does not perform direct wireless communication with portable terminal devices 200b, 200c, 200d, 200e, and 200f other than the portable terminal device 200a, and there is not a portable terminal device of a communication maintenance target. In the state in which there is not a portable terminal device of a communication maintenance target, MFP 100 sets the intensity of the radio waves at the minimum value. In this instance, the range in which the communication is uninterrupted is range RA1 which is minimum.

The range in which the communication is uninterrupted means a range in which the intensity of the radio waves received by portable terminal device 200 which is radio waves emitted from wireless communication unit 122 is a level at which the direct wireless communication between MFP 100 and portable terminal device 200 can be maintained, when the portable terminal device 200 is present in the range.

Referring to FIGS. 5 and 6, when user. A was successfully authenticated, MFP 100 acquires information which relates to the connection area of portable terminal device A from user information table 121, and sets connection area CA for portable terminal device 200a based on the acquired information. The connection area CA indicates a range as a reference for removing the portable terminal device as the communication maintenance target from communication maintenance targets. Here, it is supposed that the portable terminal device 200a is within the connection area CA.

Next, MFP 100 determines whether the portable terminal device 200a satisfies the specified condition or not. When MFP 100 determines the portable terminal device 200a satisfies the specified condition, MFP 100 regards the portable terminal device 200a as a communication maintenance target. The specified condition is a condition configured in view of whether it is going to be more likely that the target portable terminal device performs necessary communication with MFP 100 or not.

The specified condition may be that MFP 100 executed a job via portable terminal device A within a certain period from now (for example, within 3 months). In this instance, MFP 100 acquires the usage histories of user A from user information table 121, and determines whether MFP 100 executed a job via portable terminal device A within a certain period from now or not, based on the usage histories. When a job was executed within the certain period from now, MFP 100 regards the portable terminal device 200a as a communication maintenance target. Because, portable terminal device 200 with high job execution frequency is supposed to be going to be more likely to perform necessary communication with that MFP 100.

The certain period as an evaluation criterion may be able to be changed via operation panel 108. For example, if a user executed a job within a period from the present to 24 hours ago, the portable terminal device of the user may be regarded as a communication maintenance target. For example, if a user executed a job within a period from the present to 3 days ago, the portable terminal device of the user may be regarded as a communication maintenance target.

The specified condition may be the number of data items which relate to user A stored in storage device 104. In this instance, MFP 100 acquires information whether there is the box associated with the user A in storage device 104 or not, information whether the facsimile transmitting address of the user A is registered in storage device 104 or not, and information whether the mail address of user A is registered in storage device 104 or not, from user information table 121. When the number of data items which relate to user A stored in storage device 104 is more than or equal to a predetermined number (two in this embodiment), MFP 100 regards portable terminal device 200a as a communication maintenance target. When storage device 104 stores numerous data which relate to the user as the owner of a portable terminal device 200, the portable terminal device 200 is supposed to be going to be more likely to perform necessary communication with MFP 100.

For example, when there is the box associated with user A in storage device 104, storage device 104 registers the facsimile transmitting address of user A, and storage device 104 does not register the mail address of user A, the number of data items which relate to user A stored in storage device 104 is two, and the portable terminal device 200a is regarded as a communication maintenance target. When there is not a box associated with user A in storage device 104, storage device 104 registers the facsimile transmitting address of user A, and storage device 104 does not register the mail address of user A, the number of data items which relate to user A stored in storage device 104 is one, and the portable terminal device 200a is not regarded as a communication maintenance target.

The specified condition may include the above mentioned both 2 conditions. In this instance, when at least one of the above mentioned 2 conditions is satisfied, MFP 100 may regard portable terminal device 200a as a communication maintenance target.

According to user information table 121 shown in FIG. 5, for each of portable terminal devices 200a, 200b, and 200c, there is the storing area associated with the user who possesses the portable terminal device in storage device 104, the facsimile transmitting address of the user who possesses the portable terminal device is registered, and the user who possesses the portable terminal device executed a job on MFP 100 via the portable terminal device within a certain period from now. As for portable terminal device 200d, the user who possesses the portable terminal device executed a job on MFP 100 via the portable terminal device within a certain period from now. Therefore, MFP 100 determines that it is going to be more likely that each of portable terminal devices 200a, 200b, 200c, and 200d executes necessary wireless communication with MFP 100, and regards each of portable terminal devices 200a, 200b, 200c, and 200d as a communication maintenance target.

On the other hand, for each of portable terminal devices 200e and 200f, there is not a storing area associated with the user who possesses the portable terminal device in storage device 104, the facsimile transmitting address of the user who possesses the portable terminal device is not registered, and the user who possesses the portable terminal device did not execute a job on MFP 100 via the portable terminal device within a certain period from now. Therefore, MFP 100 determines the possibility of executing necessary wireless communication by each of portable terminal devices 200e and 200f with MFP 100 is low, and does not regard each of portable terminal devices 200e and 200f as a communication maintenance target.

Next, MFP 100 acquires information of the intensity of radio waves from portable terminal device 200a as a communication maintenance target. The information of the intensity of radio waves is the information of the intensity of radio waves emitted from wireless communication unit 122 and received by portable terminal device 200a. Next, MFP 100 adjusts the local intensity of radio waves which wireless communication unit 122 emits, based on the acquired information of the intensity of radio waves, so that the intensity of radio waves emitted from wireless communication unit 122 and received by portable terminal device 200a is at the minimum level in which radio waves of the direct wireless communication between MFP 100 and portable terminal device 200a are not interrupted (an example of a predetermined range in which the direct wireless communication can be maintained). MFP 100 repeats the process for acquiring the information of the intensity of radio waves and the process for adjusting the intensity of radio waves which wireless communication unit 122 emits in the following manner, to adjust the intensity of radio waves which wireless communication unit 122 emits.

MFP 100 acquires the location information of portable terminal device 200a from portable terminal device 200a as a communication maintenance target. After that, the acquisition of the location information from portable terminal device 200a as a communication maintenance target is periodically performed.

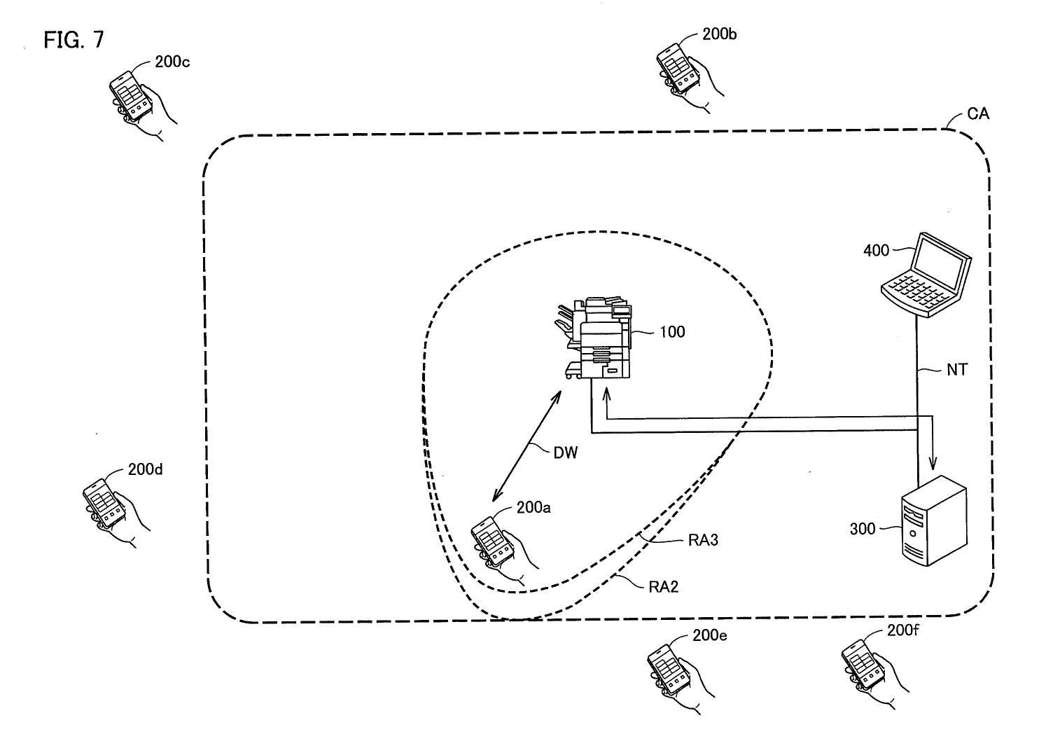

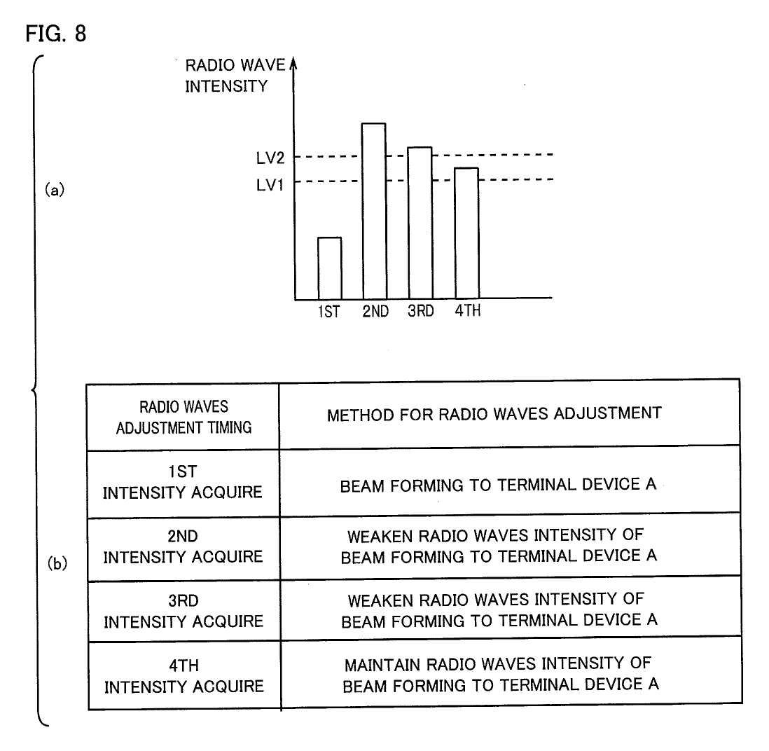

FIG. 7 shows the second figure indicating the behavior of MFP 100, according to the first embodiment of this invention. FIG. 8 shows an example of the adjustment method for the intensity of radio waves emitted from wireless communication unit 122, according to the first embodiment of this invention.

Referring to FIGS. 7 and 8, the range being over level LV1 and less than level LV2 shows the minimum level in which radio waves of direct wireless communication between MFP 100 and portable terminal device 200 are not interrupted. In other words, level LV1 shows the lower limit of the predetermined range in which direct wireless communication can be maintained, and level LV2 shows the upper limit of the predetermined range in which direct wireless communication can be maintained.

When MFP 100 acquires the first information of the intensity of radio waves from portable terminal device 200a as a communication maintenance target, it is often the case that the distance between MFP 100 and portable terminal device 200a is long and portable terminal device 200a exists outside the range RA1. Therefore, it is often the case that the intensity of radio waves firstly acquired by MFP 100 is weaker than level LV1 at which direct wireless communication can be maintained, so that the direct wireless communication may be interrupted. When the acquired intensity of radio waves is weaker than level LV1, MFP 100 executes the beam forming at the intensity of radio waves which is adequately strong with respect to portable terminal device 200a, so that the intensity of radio waves which portable terminal device 200a receives exceeds level LV1. The direction of the beam forming is configured based on the location information of portable terminal device 200a.

When MFP 100 executes the beam forming with respect to portable terminal device 200a, the intensity of radio waves in the direction of portable terminal device 200a becomes locally strong, so that the intensity of radio waves which portable terminal device 200a receives increases exponentially. The range in which the communication is uninterrupted expands locally in the direction of portable terminal device 200a, changing from range RA1 to range RA2. The intensity of radio waves which MFP 100 acquires at the second time is stronger than level LV2. When the acquired intensity of radio waves is stronger than level LV2, MFP 100 weakens the intensity of radio waves for the beam forming with respect to portable terminal device 200a, so that the intensity of radio waves which portable terminal device 200a receives becomes less than level LV2.

When MFP 100 weakens the intensity of radio waves of the beam forming with respect to portable terminal device 200a, the intensity of radio waves which portable terminal device 200a receives weakens. However, the intensity of radio waves which MFP 100 acquires at the third time is still stronger than level LV2. MFP 100 further weakens the intensity of radio waves of the beam forming with respect to portable terminal device 200a, so that the intensity of radio waves which portable terminal device 200a receives becomes less than level LV2.

When MFP 100 further weakens the intensity of radio waves of the beam forming with respect to portable terminal device 200a, the intensity of radio waves which portable terminal device 200a receives further weakens. Therefore, the intensity of radio waves which MFP 100 acquires at the fourth time exceeds level LV1 and is less than level LV2. When the acquired intensity of radio waves exceeds level LV1 and is less than level LV2, MFP 100 maintains the intensity of radio waves of the beam forming with respect to portable terminal device 200a. The range in which the communication is uninterrupted in the direction of portable terminal device 200a narrows, changing from range RA2 to range RA3.

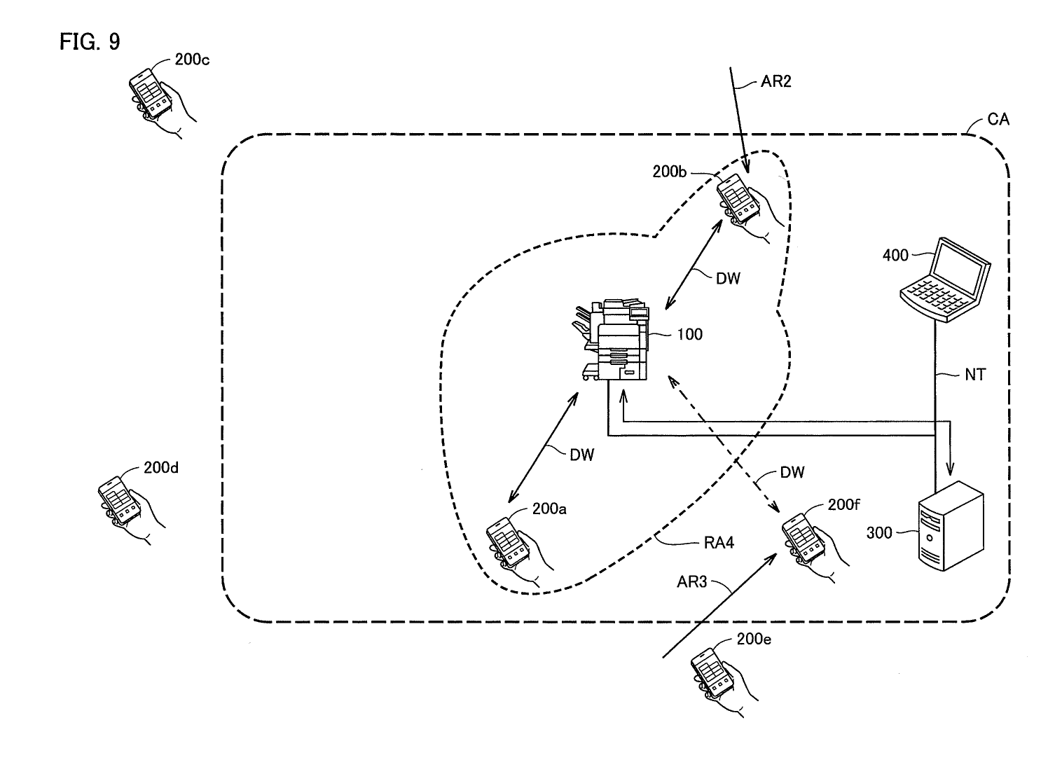

FIG. 9 shows the third figure indicating the behavior of MFP 100, according to the first embodiment of this invention.

Referring to FIG. 9, the user B who possesses the portable terminal device 200b approaches MFP 100 as shown by arrow AR2, and MFP 100 and portable terminal device 200b are ready for communicating. MFP 100 starts direct wireless communication DW with portable terminal device 200b, executes authentication process of user B, and sets connection area CA for portable terminal device 200b. MFP 100 determines whether portable terminal device 200b satisfies the specified condition or not, and regards portable terminal device 200b as a communication maintenance target. In a manner similar to portable terminal device 200a, MFP 100 adjusts the intensity of radio waves which wireless communication unit 122 emits (weakens the intensity of radio waves of the beam forming). In consequence, the range in which the communication is uninterrupted locally broadens in the direction of portable terminal device 200b, changing from range RA3 to range RA4.

Similarly, the user F who possesses the portable terminal device 200f approaches MFP 100 as shown by arrow AR3, and MFP 100 and portable terminal device 200f are ready for communicating. MFP 100 starts the direct wireless communication DW with portable terminal device 200f, executes authentication process of user F, and sets connection area CA for portable terminal device 200f. MFP 100 determines whether portable terminal device 200f satisfies the specified condition or not, and does not regard portable terminal device 200f as a communication maintenance target. MFP 100 does not adjust the intensity of radio waves which wireless communication unit 122 emits based on information indicating the intensity of radio waves received by portable terminal device 200f which is not a communication maintenance target. In consequence, direct wireless communication DW between MFP 100 and portable terminal device 200f is in a state in which that the wireless communication may be interrupted. The range in which the communication is uninterrupted remains range RA4. When portable terminal device 200f is present in range RA4, the intensity of radio waves which portable terminal device 200f receives is a level at which the direct wireless communication with MFP 100 can be maintained.

Direct wireless communication DW may be shut off for portable terminal devices 200e and 200f which are not communication maintenance targets on MFP 100 side, to avoid maintaining communication with portable terminal devices 200e and 200f when radio waves which portable terminal devices 200e and 200f which are not communication maintenance targets receive is weak. MFP 100 may beforehand receive a configuration of whether direct wireless communication DW is shut off with portable terminal devices 200e and 200f which are not to be communication maintenance targets or not, from an administrator of MFP 100 or the like.

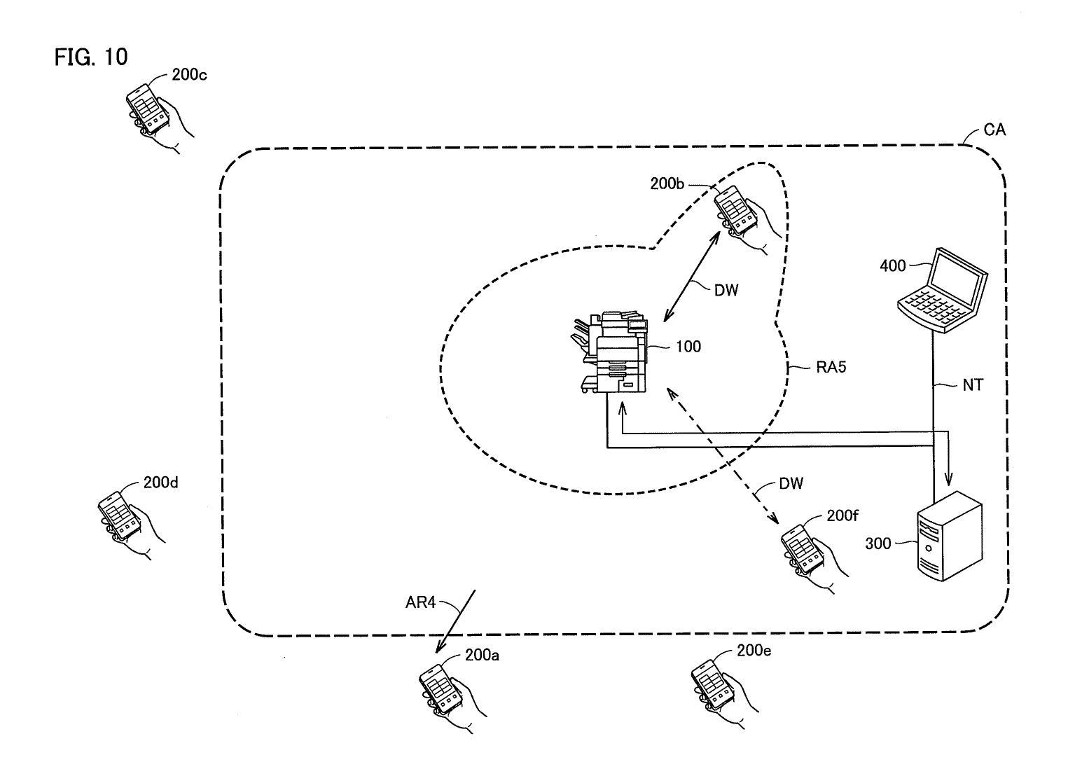

FIG. 10 shows the fourth figure indicating the behavior of MFP 100, according to the first embodiment of this invention.

Referring to FIG. 10, user A carrying the portable terminal device 200a moves out of connection area CA, as shown by arrow AR4. When it is detected that portable terminal device 200a as a communication maintenance target exists out of connection area CA, MFP 100 removes portable terminal device 200a from communication maintenance targets, and turns off the beam forming toward portable terminal device 200a. Herewith, direct wireless communication DW between MFP 100 and portable terminal device 200a is in the state in which the communication may be interrupted. In consequence, the range in which the communication is uninterrupted locally narrows, changing from range RA4 to range RA5. MFP 100 may detect whether portable terminal device 200a exists out of connection area CA, based on the location information of portable terminal device 200a, or based on the intensity of radio waves which portable terminal device 200a receives.

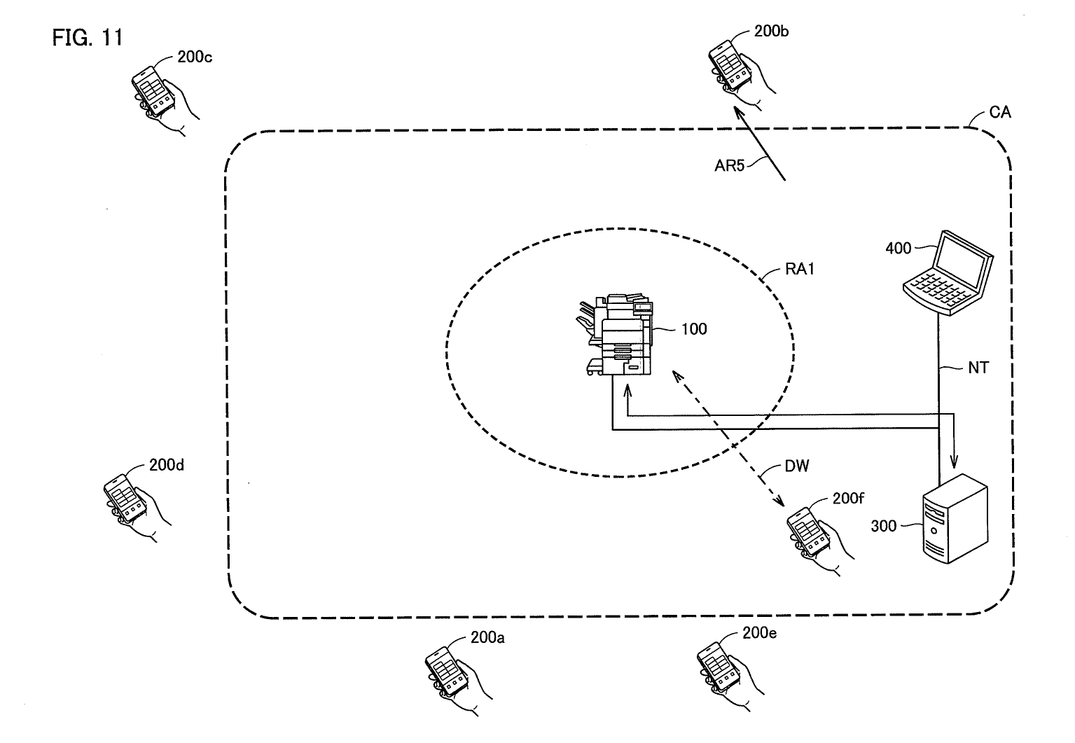

FIG. 11 shows the fifth figure indicating the behavior of MFP 100, according to the first embodiment of this invention.

Referring to FIG. 11, the user B who possesses portable terminal device 200b moves out of connection area CA, as shown by arrow AR5. When it is detected that portable terminal device 200b exists out of connection area CA, MFP 100 removes portable terminal device 200b from communication maintenance targets, and turns off the beam forming toward the portable terminal device 200b. Herewith, direct wireless communication DW between MFP 100 and portable terminal device 200b is in the state in which the communication may be interrupted. In consequence, it is a state in which there is not a portable terminal device as a communication maintenance target, and MFP 100 sets the intensity of radio waves at the minimum value. The range in which the communication is uninterrupted changes from range RA5 to range RA1.

In a state in which there is not a portable terminal device as a communication maintenance target, MFP 100 may stop radio waves (in other words, may set the minimum value of radio waves output as zero). Since portable terminal device 200f is not a communication maintenance target, the existence of direct wireless communication DW between MFP 100 and portable terminal device 200f and the location of portable terminal device 200f do not affect the intensity of radio waves which wireless communication unit 122 emits.

Connection areas with different ranges may be configured for portable terminal devices registered in user information table 121. In this instance, MFP 100 may accept configurations of connection areas for portable terminal devices in the following manner, for example.

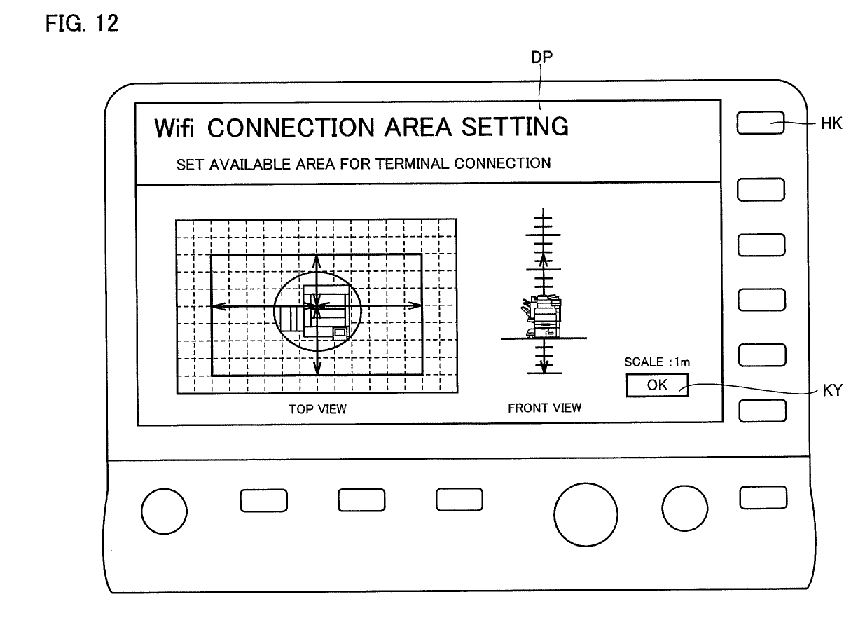

FIG. 12 schematically shows a screen for receiving configuration of a connection area displayed on a display unit DP in an operation panel 108, according to the first embodiment of this invention.

Referring to FIG. 12, operation panel 108 includes a plurality of hardware keys HK, and display unit DP which is a touch panel. When the predetermined operation was received, MFP 100 displays a message for requesting a configuration of the connection area (a range in which connection with a terminal is available), the top view and the front view of MFP 100, an “OK” key KY which is a software key, or the like on display unit DP. In the top view and the front view, back-and-forth, left-and-right, and up-and-down of the connection area centered on the MFP 100 (the distances from the location of the MFP to the boundary of connection area CA) are indicated by the arrows. When MFP 100 receives a pinch-in operation, a pinch out operation, or the like on display unit DP, MFP 100 enlarges or reduces the back, the forth, the left, the right, the up, or the down of the connection area in accordance with the received operation. When key KY is pressed, MFP 100 fixes the connection area, and registers it in association with the portable terminal device in user information table 121.

The configuration of the connection area is set by the user of portable terminal device 200, the administrator of MFP 100, or the like.

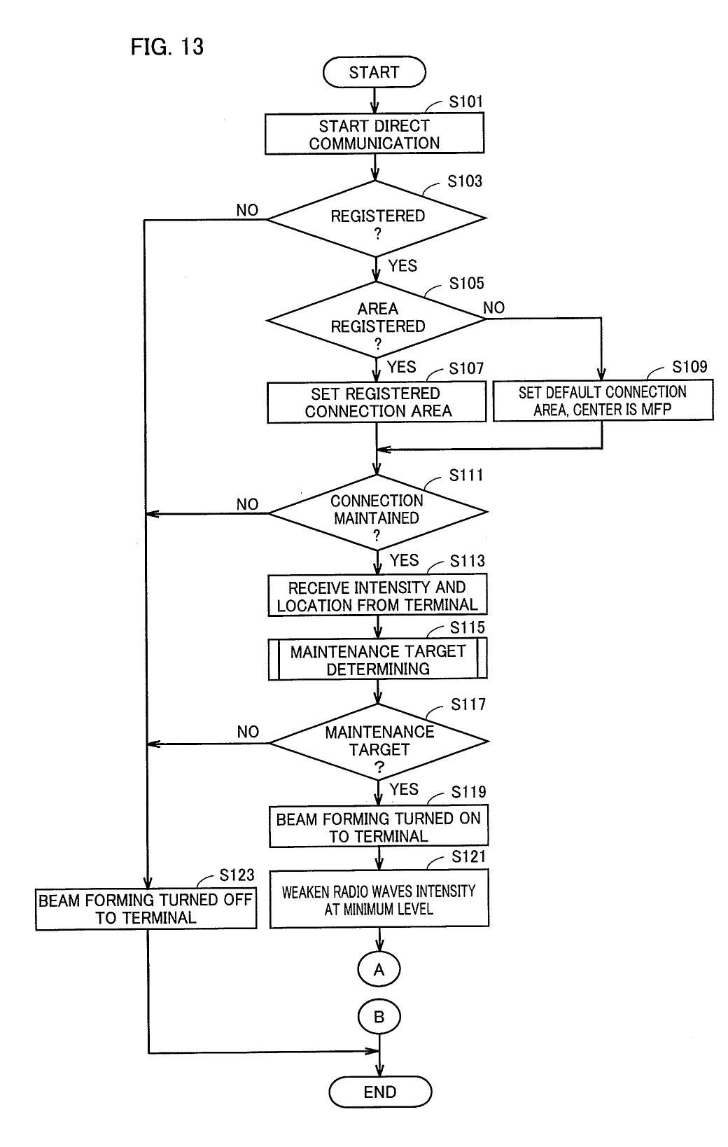

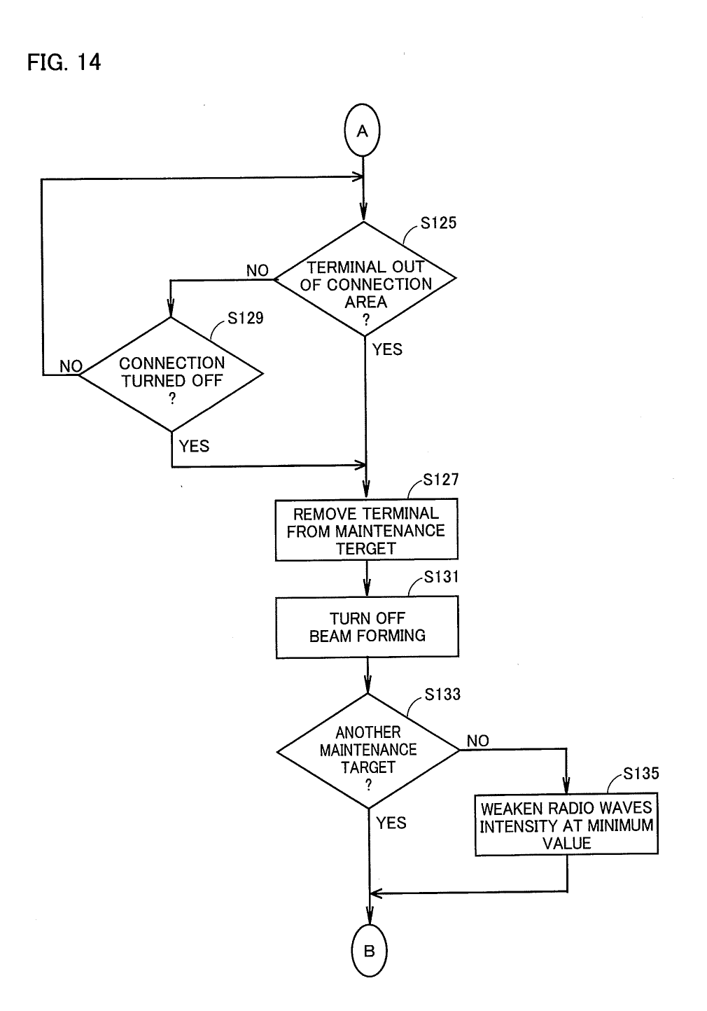

FIGS. 13 and 14 show a flowchart indicating the behavior of MFP 100, according to the first embodiment of this invention.

Referring to FIG. 13, when CPU 101 starts the direct wireless communication with a portable terminal device (S101), CPU 101 determines whether the portable terminal device which is the communication partner is registered in user information table 121 or not (S103).

At step S103, when the portable terminal device as the communication partner is registered in user information table 121 (YES at S103), CPU 101 determines whether a connection area associated with the portable terminal device as the communication partner is registered in user information table 121 or not (S105).

At step S105, when a connection area associated with the portable terminal device as the communication partner is registered in user information table 121 (YES at S105), CPU 101 sets the registered connection area (S107), and steps in the process of step S111.

At step S105, when a connection area associated with the portable terminal device as the communication partner is not registered in user information table 121 (NO at S105), CPU 101 sets the default connection area centered on the MFP 100 (S109), and steps in the process of step S111.

At step S111, CPU 101 determines whether the direct wireless connection with the portable terminal device as the communication partner is maintained or not (S111).

At step S111, when the direct wireless connection with the portable terminal device as the communication partner is maintained (YES at S111), CPU 101 receives the intensity of radio waves and the location information from the portable terminal device as the communication partner (S113), and executes the communication maintenance target determining process which will be explained later (S115). Next, CPU 101 determines whether the portable terminal device as the communication partner is regarded as a communication maintenance target or not, on the result of the communication maintenance target determining process (S117).

At step S117, when the portable terminal device as the communication partner is regarded as a communication maintenance target (YES at S117), CPU 101 turns on the beam forming toward the portable terminal device as the communication partner (S119). Next, CPU 101 weakens the intensity of radio waves of the beam forming with respect to the portable terminal device as the communication partner at the minimum level at which the communication with the portable terminal device as the communication partner is uninterrupted (S121), and steps in the process of step S125 in FIG. 14.

When the portable terminal device as the communication partner is not registered in user information table 121 at step S103 (NO at S103), when the direct wireless connection with the portable terminal device as the communication partner is not maintained at step S111 (NO at S111), or when the portable terminal device as the communication partner is not regarded as a communication maintenance target at step S 117 (NO at S117), CPU 101 does not perform the beam forming with respect to the portable terminal device as the communication partner (S123), and terminates the process.

Referring to FIG. 14, at step S125, CPU 101 determines whether the portable terminal device as the communication partner moved out of the connection area or not (S125).

At step S125, when the portable terminal device as the communication partner does not move out of the connection area (NO at S125), CPU 101 determines whether the communication with the portable terminal device as the communication partner was shut off or not (S129).

At step S129, when the communication with the portable terminal device as the communication partner is not shut off (NO at S129), CPU 101 steps in the process of step S125.

When the portable terminal device as the communication partner moved out of the connection area at step S125 (YES at S125), or when the communication with the portable terminal device as the communication partner was shut off at step S129 (YES at S129), CPU 101 removes the portable terminal device as the communication partner from communication maintenance targets (S127), and turns off the beam forming toward the portable terminal device as the communication partner (S131). Next, CPU 101 determines whether there is another portable terminal device which is a communication maintenance target or not (S133).

At step S133, when there is another portable terminal device as a communication maintenance target (YES at S133), CPU 101 terminates the process.

At step S133, when there is not another portable terminal device as a communication maintenance target (NO at S133), CPU 101 weakens the intensity of radio waves at the minimum value (S135), and terminates the process. At step S135, CPU 101 may stop emitting radio waves.

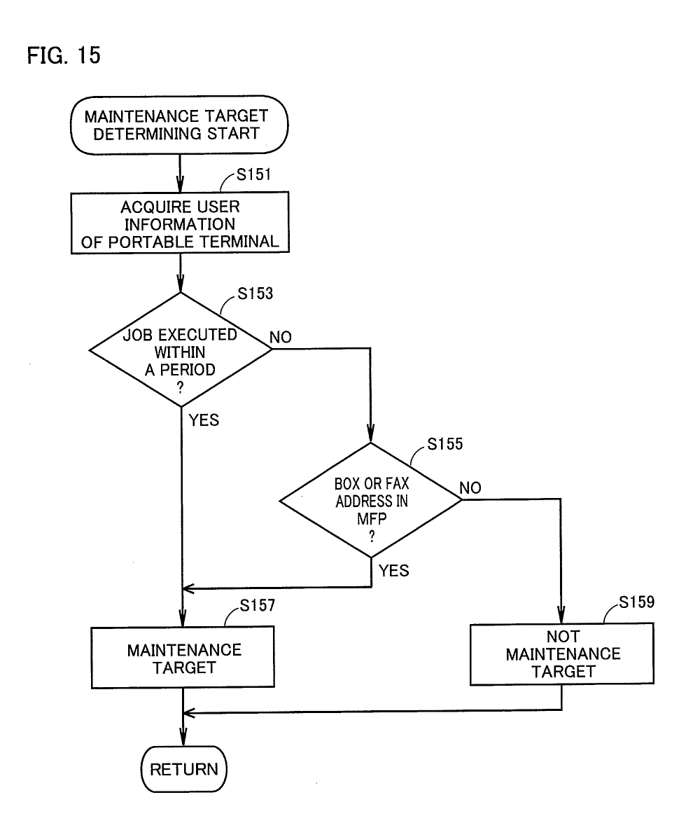

FIG. 15 shows a subroutine of the communication maintenance target determining process (S115) in FIG. 13.

Referring to FIG. 15, in the communication maintenance target determining process, CPU 101 acquires information relates to the user of the portable terminal device as the communication partner (S151), and determines whether there is the job executed by MFP 100 within the certain period or not (S153).

At step S153, when there is not the job executed by MFP 100 within the certain period (NO at S153), CPU 101 determines whether there is the box or the facsimile transmitting address in MFP 100 or not (S155).

At step S153, when there is the job executed by MFP 100 within the certain period (YES at S153), or when there is the box or the facsimile transmitting address in MFP 100 at step S155 (YES at S155), CPU 101 regards the portable terminal device as the communication partner is a communication maintenance target (S157), and returns to the main flowchart.

At step S155, when there is neither the box nor the facsimile transmitting address in MFP 100 (NO at S155), CPU 101 does not regard the portable terminal device as the communication partner is a communication maintenance target (S159), and returns to the main flowchart.

According to this embodiment, an MFP performs the beam forming toward a portable terminal device which is going to be more likely to perform necessary communication with the MFP. During the beam forming, the MFP weakens the intensity of radio waves of the beam forming with respect to the portable terminal device at the minimum level at which radio waves of the direct wireless communication with the portable terminal device are not interrupted. Herewith, the power consumption of the MFP can be reduced.

Further, it is determined whether a portable terminal device is going to be more likely to perform necessary communication with the MFP or not, based on whether the portable terminal device is registered or not, whether a job was executed via the portable terminal device recently or not, whether information which relates to the user of the portable terminal device is stored or not, whether the portable terminal device exists within the connection area, or the like. Hence, the target to which the beam forming executes can be suitably determined.

The beam forming is not executed for a portable terminal device with low possibility of performing necessary communication with the MFP, such as a portable terminal device which is not a communication maintenance target, a portable terminal device moved away from the MFP, a portable terminal device moved out of the connection area. Therefore, the intensity of radio waves which the wireless communication unit emits can be reduced, to reduce the power consumption. When the number of portable terminal devices with which MFP can simultaneously execute direct wireless communication is limited, the limited number of portable terminal devices can be effectively used.

When there is not a portable terminal device which is going to be more likely to perform necessary communication with the MFP, the intensity of radio waves which the wireless communication unit emits is set at the minimum value. Hence, the power consumption can be reduced.

### The Second Embodiment

In this embodiment, the case in which MFP 100 works in conjunction with an entering/leaving room system will be explained. Connection areas are not set for users.

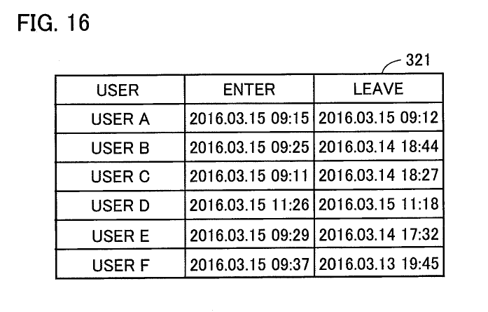

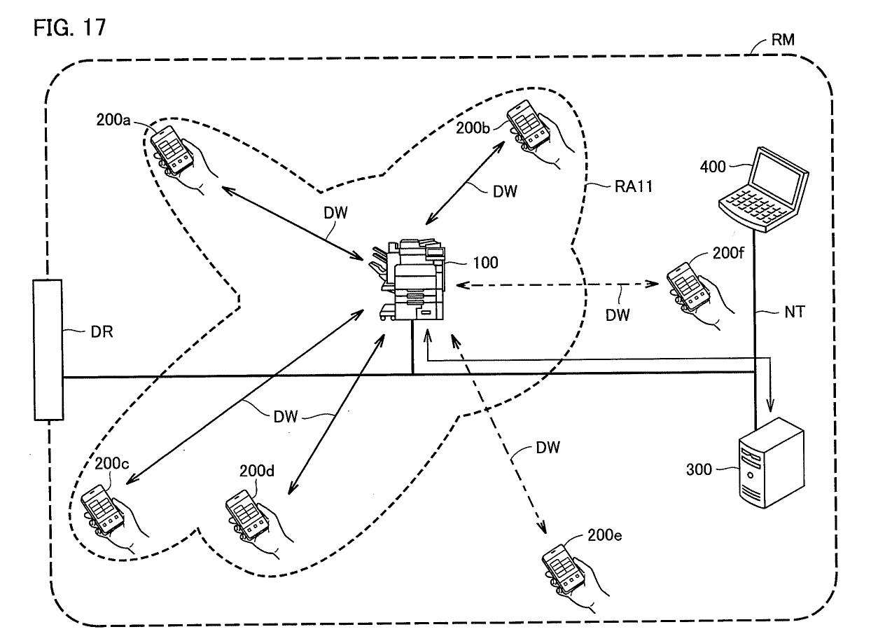

FIG. 16 shows an example of entering/leaving room table 321 stored in storage device 304 of a server 300, according to the second embodiment of this invention. FIG. 17 shows the first figure indicating the behavior of MFP 100, according to the second embodiment of this invention.

Referring to FIGS. 16 and 17, the entering/leaving room table 321 records the entering/leaving room histories of the users of MFP 100. The entering/leaving room histories include time and date of entering the room RM and time and date of leaving the room RM. The server 300 is an entering/leaving room system to perform the administration of entering/leaving room for the room RM, by using entering/leaving room table 321. When the user of portable terminal device 200 enters the room RM from the door DR, the user performs the operation for entering the room by a method for moving his/her own ID card closer to a sensor (which is not shown in Figures) installed on the door DR, for example. The server 300 acquires the user ID via the sensor, and records the time and date of the entering the room of the user on entering/leaving room table 321. When the user of portable terminal device 200 exits the room RM from the door DR, the user performs the operation for leaving the room by a method for moving his/her own ID card closer to a sensor SE, for example. The server 300 acquires the user ID via the sensor, and records the time and date of the leaving the room of the user on entering/leaving room table 321.

MFP 100 acquires the entering/leaving room histories recorded in entering/leaving room table 321 from server 300. MFP 100 can determine whether each of users is in the room or out of the room, based on which is later (newer), the time and date of the entering the room or the time and date of the leaving the room. MFP 100 may acquire the entering/leaving room histories for all the users recorded on entering/leaving room table 321 every time an arbitrary time elapses. MFP 100 may acquire the entering/leaving room history updated each time entering/leaving room table 321 is updated.

Referring to FIG. 17, all the users of portable terminal devices 200a, 200b, 200c, 200d, 200e and 200f are in the room RM, and all the portable terminal devices 200a, 200b, 200c, 200d, 200e and 200f exist in the room RM. MFP 100 are performing direct wireless communication DW with each of portable terminal devices 200a, 200b, 200c, 200d, 200e and 200f. Portable terminal devices 200a, 200b, 200c and 200d are regarded as communication maintenance targets, and portable terminal devices 200e and 200f are not regarded as communication maintenance targets.

MFP 100 is performing the beam forming to each of portable terminal devices 200a, 200b, 200c and 200d which are communication maintenance targets, and the range in which the communication is uninterrupted is range RA11. The intensity of radio waves which each of portable terminal devices 200a, 200b, 200c and 200d receives is at the minimum level at which the radio waves of the direct wireless communication with MFP 100 are not interrupted, and the intensity of radio waves which each of portable terminal devices 200e and 200f receives is at a level at which the direct wireless communication with MFP 100 may be interrupted.

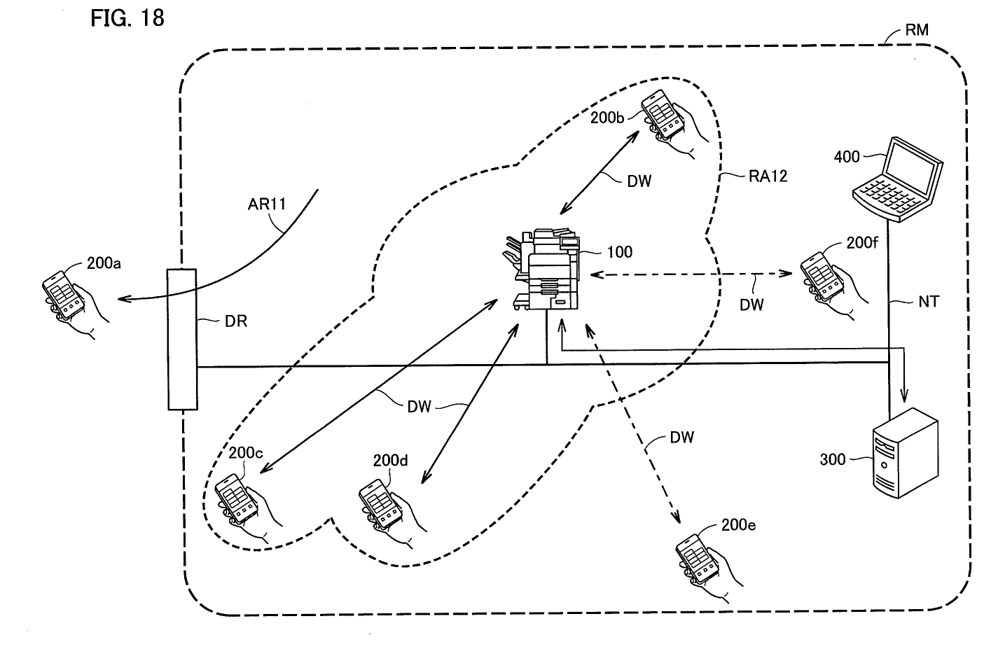

FIG. 18 shows the second figure indicating the behavior of MFP 100, according to the second embodiment of this invention.

Referring to FIG. 18, the user A carrying the portable terminal device 200a performs the operation for leaving the room, and leaves the room RM as shown by arrow AR11. When MFP 100 detects that the user A left the room RM based on the information recorded on entering/leaving room table 321, MFP 100 removes portable terminal device 200a from the communication maintenance targets, and turns off the beam forming toward portable terminal device 200a. Herewith, the direct wireless communication DW between MFP 100 and portable terminal device 200a is in the state in which the communication may be interrupted. In consequence, the range in which the communication is uninterrupted narrows locally, changing range RA11 to range RA12.

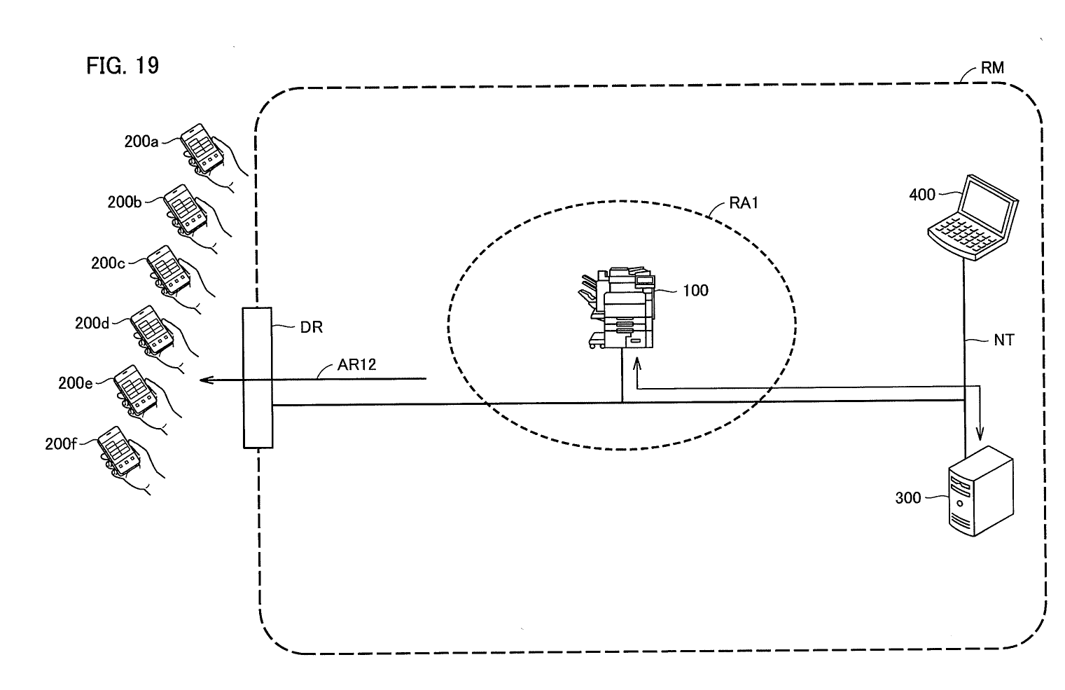

FIG. 19 shows the third figure indicating the behavior of MFP 100, according to the second embodiment of this invention.

Referring to FIG. 19, the user B, the user C, the user D, the user E, and the user F, who possess the portable terminal devices 200b, 200c, 200d, 200e and 200f respectively perform the operation for leaving the room, and leave the room RM as shown by arrow AR12. When MFP 100 detects that all the users of portable terminal devices 200b, 200c, 200d, 200e and 200f which are the communication maintenance target left the room RM, MFP 100 removes portable terminal devices 200b, 200c and 200d from the communication maintenance targets, and turns off the beam forming toward portable terminal devices 200b, 200c and 200d. Herewith, direct wireless communications DW between MFP 100 and portable terminal devices 200b, 200c and 200d are in the state in which the communications may be interrupted. In consequence, since there is not a portable terminal device as a communication maintenance target, MFP 100 sets the intensity of radio waves at the minimum value. The range in which the communication is uninterrupted is changed from range RA12 to range RA1.

Since portable terminal devices 200e and 200f are not communication maintenance targets, whether user E or user F left the room RM or not does not affect the intensity of radio waves which wireless communication unit 122 emits.

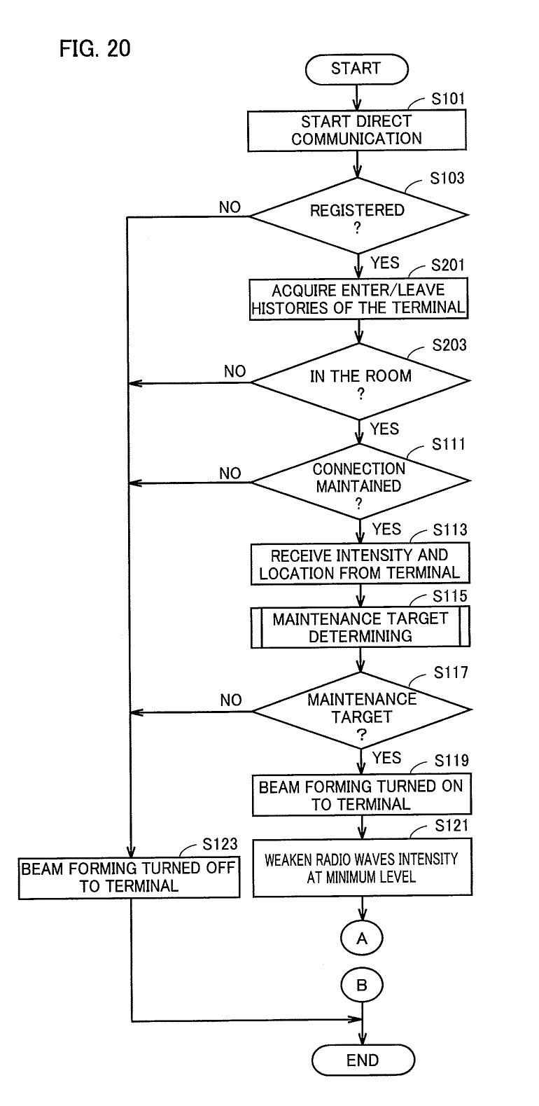

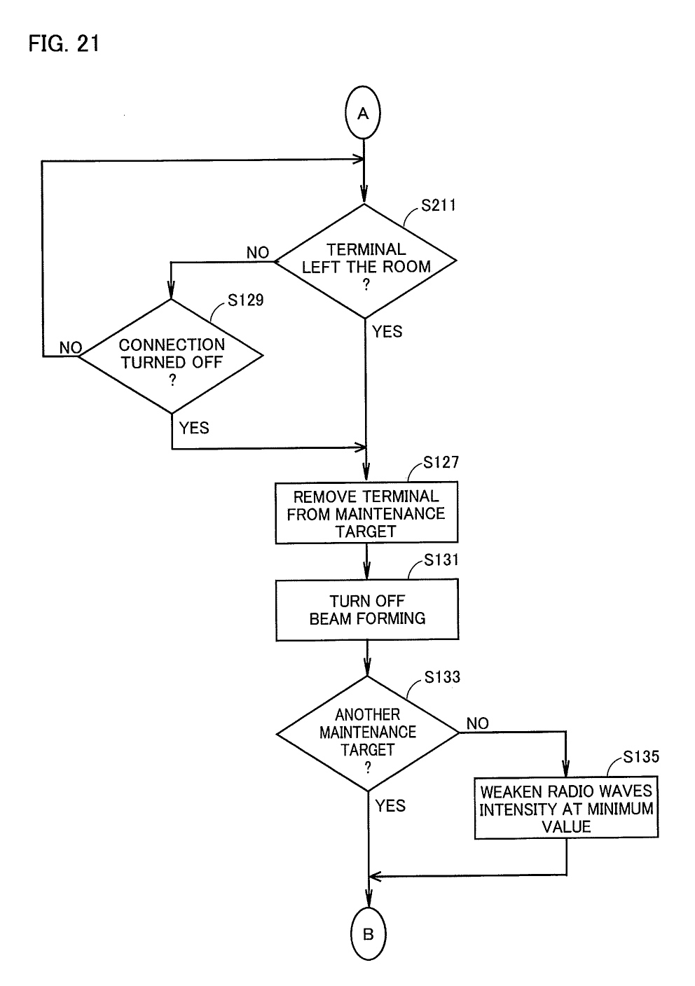

FIGS. 20 and 21 show a flowchart indicating the behavior of MFP 100, according to the second embodiment of this invention.

Referring to FIG. 20, at step S103 in the flowchart shown in FIG. 13, when it is determined that the portable terminal device as the communication partner is registered in user information table 121 (YES at S103), CPU 101 acquires the entering/leaving room histories for the user of the portable terminal device as the communication partner (S201), and determines whether the user of the portable terminal device as the communication partner is in the room or not (S203).

At step S203, when it is determined that the user of the portable terminal device as the communication partner is in the room (YES at S203), CPU 101 steps in the process of step S111 in the flowchart shown in FIG. 13.

At step S203, when it is determined that the user of the portable terminal device as the communication partner is out of the room (NO at S203), CPU 101 does not perform the beam forming with respect to the portable terminal device as the communication partner (S123), and terminates the process.

At step S121 in the flowchart shown in FIG. 13, after weakening the intensity of radio waves of the beam forming with respect to the portable terminal device as the communication partner at the minimum level at which the communication with the portable terminal device as the communication partner is uninterrupted (S121), CPU 101 steps in the process of step S211 in FIG. 21.

Referring to FIG. 21, at step S211, CPU 101 acquires the entering/leaving room histories of the user of the portable terminal device as the communication partner, and determines whether the user of the portable terminal device as the communication partner left the room or not (S211).

At step S211, when it is determined that the user of the portable terminal device as the communication partner left the room (YES at S211), CPU 101 steps in the process of step S127 in FIG. 14.

At step S211, when it is determined that the user of the portable terminal device as the communication partner did not leave the room (NO at S211), CPU 101 determines whether the communication with the portable terminal device as the communication partner was shut off or not (S129).

At step S129, when it is determined that the communication with the portable terminal device as the communication partner was not shut off (NO at S129), CPU 101 steps in the process of step S211.

At step S129, when it is determined that the communication with the portable terminal device as the communication partner was shut off (YES at S129), CPU 101 steps in the process of step S127 in FIG. 14.

In this embodiment, the structures of the image processing system and the processes of MFP 100 other than the above described are similar to the first embodiment. The explanations are not repeated.

According to this embodiment, the beam forming is not performed with respect to a portable terminal device possessed by the user who left the room in which the MFP is installed. Hence, since the intensity of radio waves which the wireless communication unit emits can be reduced, the power consumption can be reduced.

Further, it is determined that it is going to be more likely that a portable terminal device performs necessary communication with the MFP or not, based on whether the user of the portable terminal device left the room or not, for example. Hence, the target to which the beam forming is performed can be suitably determined.

### The Third Embodiment

According to this embodiment, the case in which MFP 100 does not have the beam forming function will be explained.

Here, it is assumed that MFP 100 does not perform direct wireless communication with each of portable terminal devices 200b, 200c, 200d, 200e and 200f, other than portable terminal device 200a, in a state in which there is not a portable terminal device as a communication maintenance target, and MFP 100 starts the direct wireless communication DW with portable terminal device 200a (the situation shown in FIG. 6). In the situation, MFP 100 performs processes similar to the first embodiment, to regards portable terminal device 200a as a communication maintenance target.

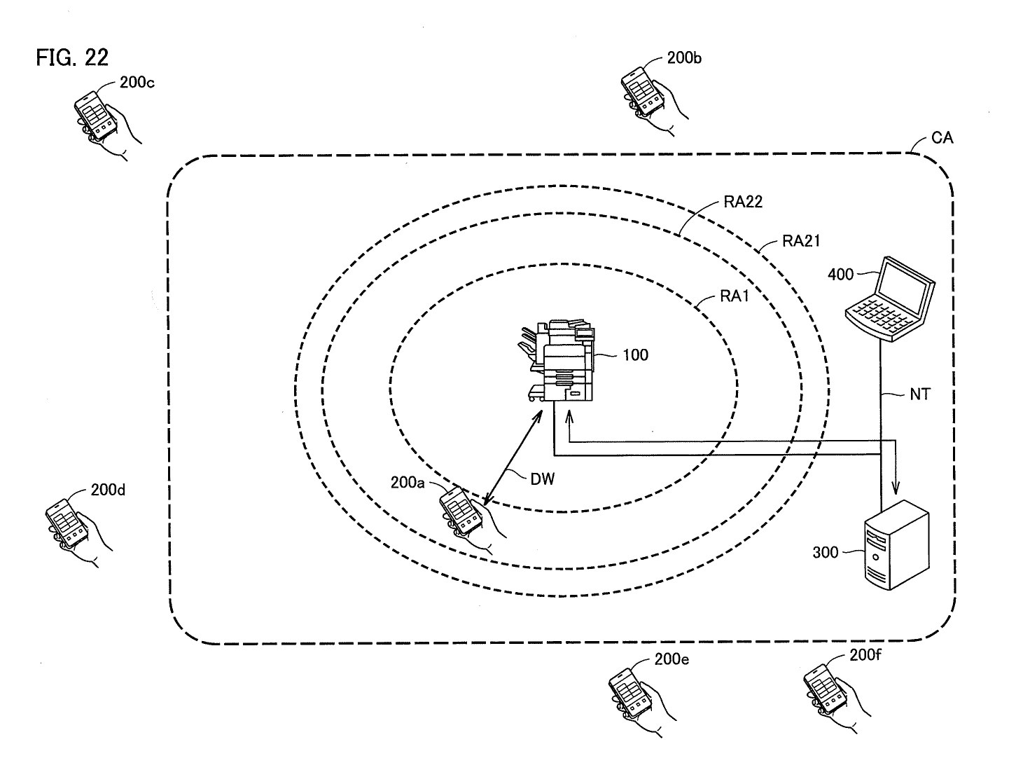

FIG. 22 shows the first figure indicating the behavior of MFP 100, according to the third embodiment of this invention.

Referring to FIG. 22, the MFP 100 acquires the information of the intensity of radio waves from portable terminal device 200a as the communication maintenance target. MFP 100 adjusts the intensity of radio waves which wireless communication unit 122 emits, so that the intensity of radio waves which portable terminal device 200a receives which is radio waves emitted from wireless communication unit 122 is at the minimum level at which radio waves of the direct wireless communication between MFP 100 and portable terminal device 200 are not interrupted, based on the acquired information of the intensity of radio waves. Since wireless communication unit 122 does not have a beam forming function, MFP 100 adjusts the intensity of radio waves in all directions from the MFP 100 without exception. MFP 100 repeats the acquiring process of the information of the intensity of radio waves, and the adjusting process of the intensity of radio waves which wireless communication unit 122 emits, in the following manner, to adjust the intensity of radio waves which wireless communication unit 122 emits.

MFP 100 acquires the location information of portable terminal device 200a from portable terminal device 200a as the communication maintenance target. After that, the location information is periodically acquired from portable terminal device 200a as the communication maintenance target.

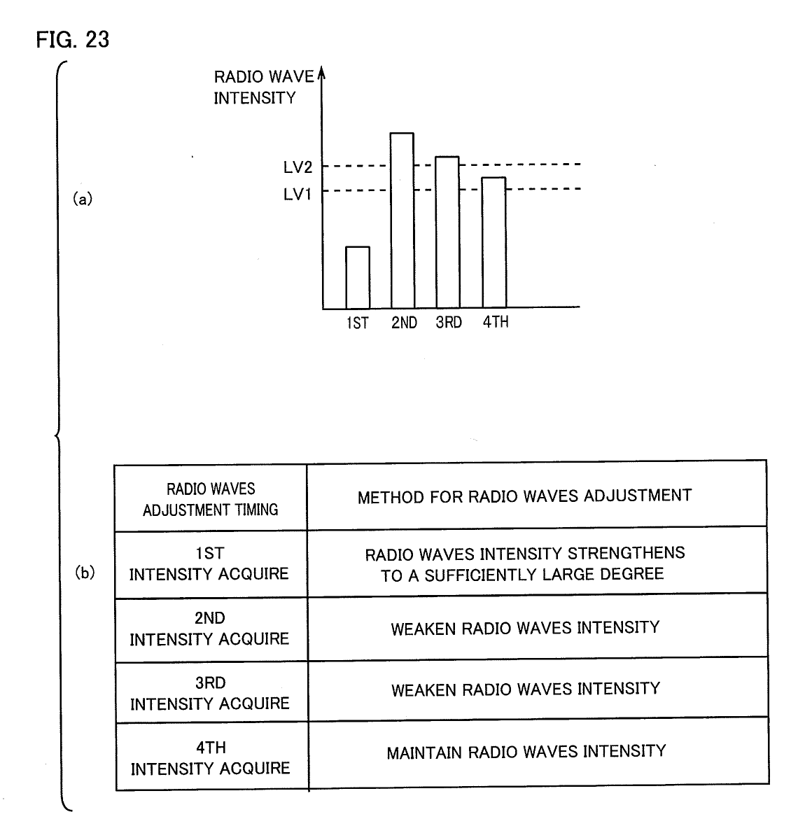

FIG. 23 shows an example of the adjustment method of the intensity of radio waves emitted from wireless communication unit 122, according to the third embodiment of this invention.

Referring to FIGS. 22 and 23, when the information of the intensity of radio waves was firstly acquired from portable terminal device 200a as the communication maintenance target, it is often the case that the distance between MFP 100 and portable terminal device 200a is long, and portable terminal device 200a exists outside of the range RA1. Therefore, it is often the case that the intensity of radio waves which MFP 100 acquired firstly is weaker than level LV1 at which the direct wireless communication can be maintained, and the intensity of radio waves which MFP 100 acquired firstly is at a level at which the direct wireless communication may be interrupted. When the acquired intensity of radio waves is weaker than level LV1, MFP 100 strengthens the radio waves emitted from wireless communication unit 122 to a sufficiently large degree, so that the intensity of radio waves which portable terminal device 200a receives exceeds level LV1.

When the radio waves emitted from wireless communication unit 122 strengthens to a sufficiently large degree, the intensity of radio waves which portable terminal device 200a receives exponentially increases. The range in which the communication is uninterrupted is enlarged in all directions from the MFP 100 without exception, changing from range RA1 to range RA21. The intensity of radio waves which MFP 100 secondary acquires is stronger than level LV2 which is an arbitrary level which exceeds level LV1. When the acquired intensity of radio waves is stronger than level LV2, MFP 100 weakens the radio waves emitted from wireless communication unit 122, so that the intensity of radio waves which portable terminal device 200a receives is less than level LV2.

When the radio waves emitted from wireless communication unit 122 weakens, the intensity of radio waves which portable terminal device 200a receives decreases. However, the intensity of radio waves which MFP 100 acquires at the third time is still stronger than level LV2. MFP 100 further weakens the radio waves emitted from wireless communication unit 122, so that the intensity of radio waves which portable terminal device 200a receives is less than level LV2.

When the radio waves emitted from wireless communication unit 122 further weakens, the intensity of radio waves which portable terminal device 200a receives further decreases. Therefore, the intensity of radio waves which MFP 100 acquires at the fourth time exceeds level LV1 and is less than level LV2. When the acquired intensity of radio waves exceeds level LV1 and is less than level LV2, MFP 100 maintains the intensity of radio waves which wireless communication unit 122 emits. The range in which the communication is uninterrupted narrows in all directions from the MFP 100 without exception, changing from range RA21 to range RA22.

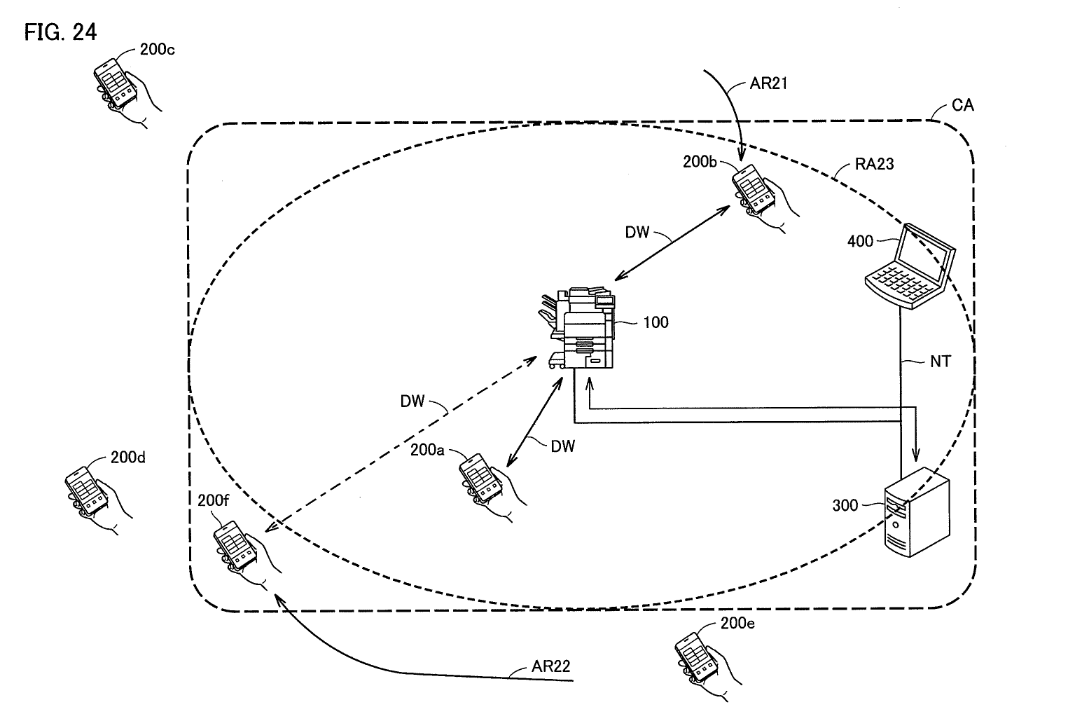

FIG. 24 shows the second figure indicating the behavior of MFP 100, according to the third embodiment of this invention.

Referring to FIG. 24, when the user B who possesses the portable terminal device 200b approaches MFP 100 as shown by arrow AR21, and MFP 100 and portable terminal device 200b are ready for communicating, MFP 100 performs processes similar to the first embodiment, to regard portable terminal device 200b as a communication maintenance target. In consequence, portable terminal devices 200a and 200b are communication maintenance targets.

When there are a plurality of portable terminal devices which are communication maintenance targets, MFP 100 adjusts the intensity of radio waves which wireless communication unit 122 emits, so that the intensity of radio waves received by a portable terminal device which receives the weakest radio waves emitted from wireless communication unit 122 (a portable terminal device farthest away from MFP 100) among the portable terminal devices which are communication maintenance targets is at the minimum level at which radio waves of the direct wireless communication with MFP 100 are not interrupted.

In FIG. 24, the distance between portable terminal device 200b and MFP 100 is longer than the distance between portable terminal device 200a and MFP 100. Hence, the intensity of radio waves which portable terminal device 200b receives is weaker than the intensity of radio waves which portable terminal device 200a receives. Therefore, MFP 100 adjusts the intensity of radio waves which wireless communication unit 122 emits, so that the intensity of radio waves received by portable terminal device 200b which receives the weakest radio waves among portable terminal devices 200 as communication maintenance targets is at the minimum level at which radio waves of the direct wireless communication with MFP 100 are not interrupted. In consequence, the range in which the communication is uninterrupted are enlarged in all directions from the MFP 100 without exception, changing from range RA22 to range RA23.

After user B approached MFP 100, the user F who possesses the portable terminal device 200f approaches MFP 100 as shown by arrow AR22. When MFP 100 and portable terminal device 200f are ready for communicating, MFP 100 performs processes similar to the first embodiment, and does not regard portable terminal device 200f as a communication maintenance target. MFP 100 does not adjust the intensity of radio waves which wireless communication unit 122 emits, based on information indicating the intensity of radio waves received by portable terminal device 200f which is not a communication maintenance target. In consequence, direct wireless communication DW between MFP 100 and portable terminal device 200f is in the state in which the communication may be interrupted. The range in which the communication is uninterrupted remains range RA23.

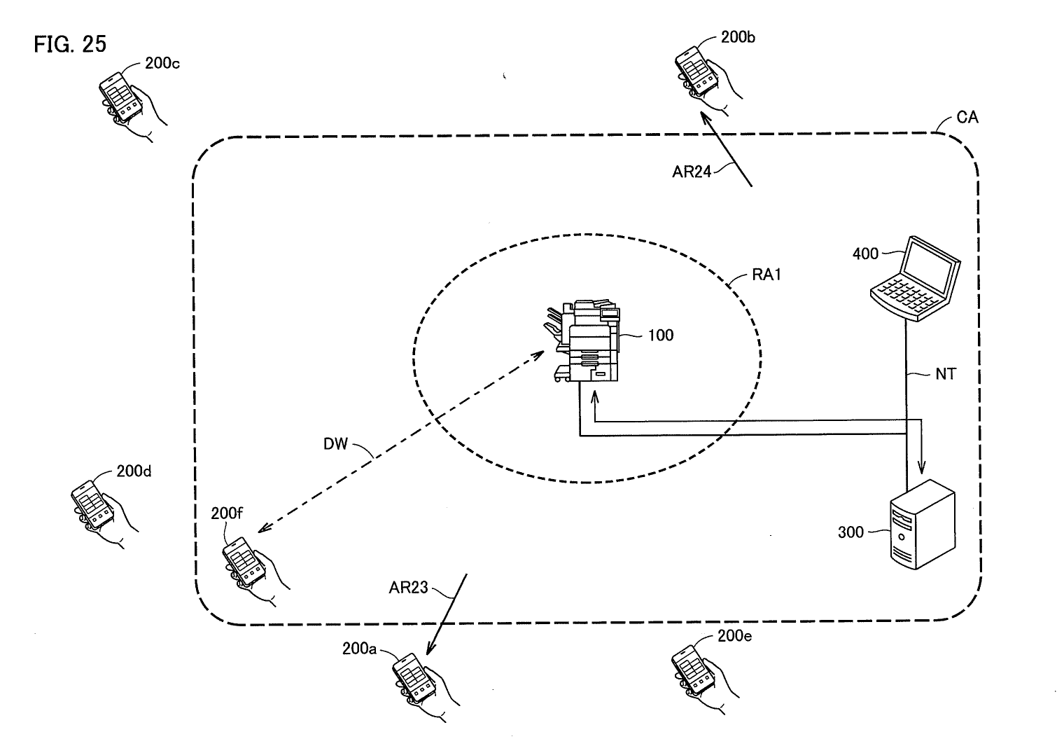

FIG. 25 shows the third figure indicating the behavior of MFP 100, according to the third embodiment of this invention.

Referring to FIG. 25, user A carrying the portable terminal device 200a moves out of connection area CA, as shown by arrow AR23. user B carrying the portable terminal device 200b moves out of connection area CA, as shown by arrow AR24. When MFP 100 detects that portable terminal device 200a and portable terminal device 200b exist out of connection area CA, MFP 100 removes portable terminal device 200a and 200b from communication maintenance targets. Herewith, direct wireless communication DW between MFP 100 and each of portable terminal devices 200a and 200b is in the state in which the communication may be interrupted. In consequence, there is not a portable terminal device which is a communication maintenance target, and MFP 100 sets the intensity of radio waves at the minimum value. The range in which the communication is uninterrupted narrows in all directions from the MFP 100 without exception, changing from range RA23 to range RA1.

Since portable terminal device 200f is not a communication maintenance target, the existence of direct wireless communication DW between MFP 100 and portable terminal device 200f, and the location of portable terminal device 200f do not affect the intensity of radio waves which wireless communication unit 122 emits.

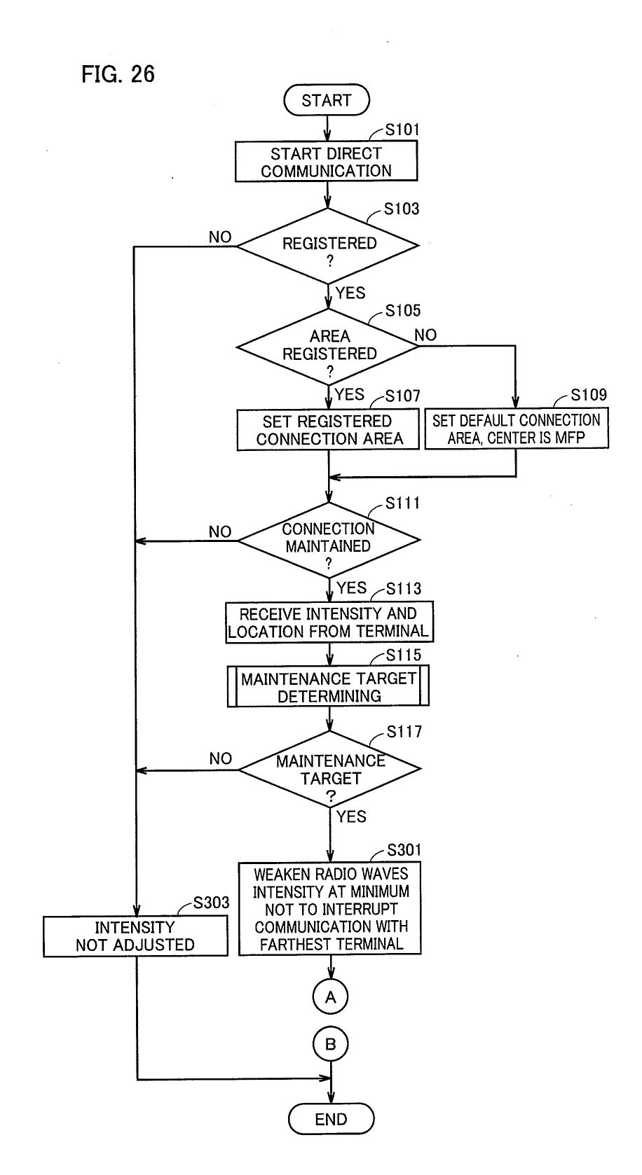

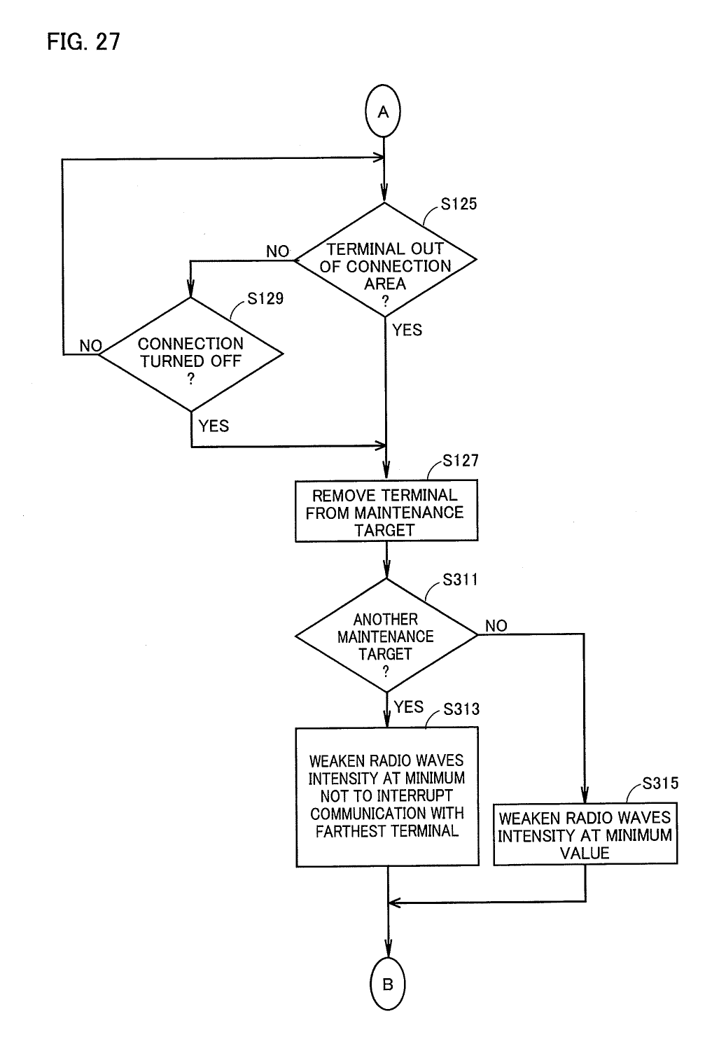

FIGS. 26 and 27 show a flowchart indicating the behavior of MFP 100, according to the third embodiment of this invention.

Referring to FIG. 26, at step S117 in the flowchart shown in FIG. 13, when it is determined that the portable terminal device as the communication partner is regarded as a communication maintenance target (YES at S117), CPU 101 weakens the intensity of radio waves which wireless communication unit 122 emits, so that the intensity of radio waves received by a portable terminal device which farthest away from MFP 100 among portable terminal devices which are communication maintenance targets is at the minimum level at which the radio waves of the direct wireless communication are not interrupted (S301), and steps in the process of step S125 in FIG. 27.

When it is determined that the portable terminal device as the communication partner is not registered in user information table 121 at step S103 in the flowchart shown in FIG. 13 (NO at S103), when it is determined that the direct wireless connection with the portable terminal device as the communication partner is not maintained at step S111 in the flowchart shown in FIG. 13 (NO at S111), or when it is determined that the portable terminal device as the communication partner is not regarded as a communication maintenance target at step S117 in the flowchart shown in FIG. 13 (NO at S117), CPU 101 does not adjust the intensity of radio waves (S303), and terminates the process.

Referring to FIG. 27, at step S127 of the flowchart shown in FIG. 13, the portable terminal device as the communication partner is removed from communication maintenance targets (S127). After that, CPU 101 determines whether another portable terminal device as a communication maintenance target exists or not (S311).

At step S311, when it is determined that another portable terminal device as a communication maintenance target exists (YES at S311), CPU 101 weakens the intensity of radio waves which wireless communication unit 122 emits, so that the intensity of radio waves which a portable terminal device farthest away from MFP 100 among portable terminal devices which are communication maintenance targets receives is at the minimum level at which radio waves of the direct wireless communication are not interrupted (S313), and terminates the process.

At step S311, when it is determined that another portable terminal device as a communication maintenance target does not exist (NO at S311), CPU 101 weakens the intensity of radio waves at the minimum value (S315), and terminates the process. At step S315, CPU 101 may stop emitting radio waves.

According to this embodiment, the MFP weakens the intensity of radio waves which the wireless communication unit emits in all the directions from the MFP without exception at the minimum level at which radio waves of the direct wireless communication with a portable terminal device which is going to be more likely to perform necessary communication with the MFP are not interrupted. Herewith, power consumption of the MFP can be reduced.

### The Fourth Embodiment

According to the embodiment, the case in which MFP 100 does not have the beam forming function and MFP 100 works in conjunction with an entering/leaving room system will be explained. Connection areas are not configured for users.

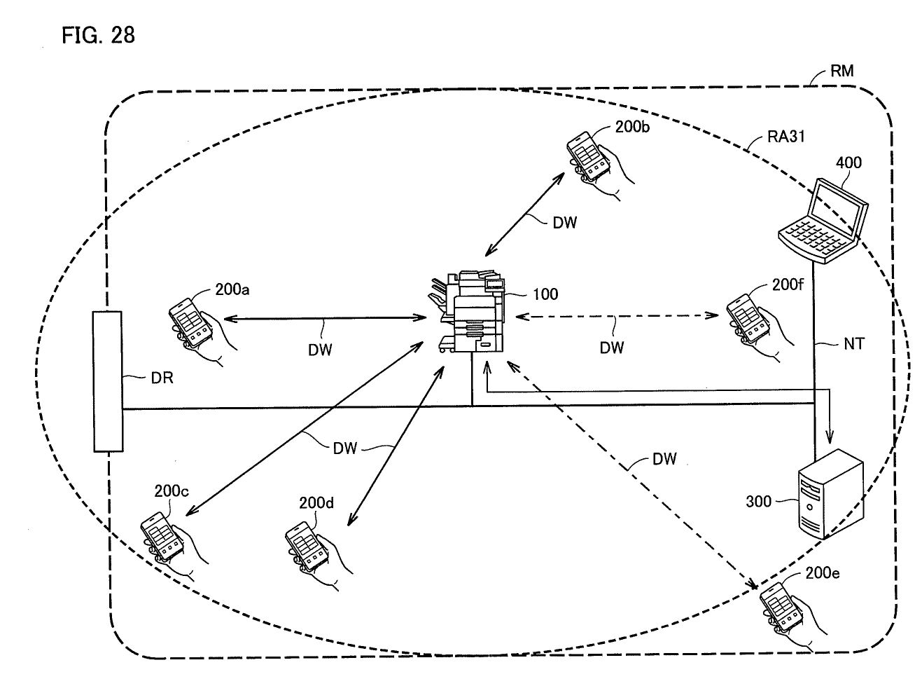

FIG. 28 shows the first figure indicating the behavior of MFP 100, according to the fourth embodiment of this invention.

Referring to FIG. 28, all the users of portable terminal devices 200a, 200b, 200c, 200d, 200e, and 200f are in the room RM, and all the portable terminal devices 200a, 200b, 200c, 200d, 200e, and 200f exist in the room RM. MFP 100 are performing direct wireless communication DW with portable terminal devices 200a, 200b, 200c, 200d, 200e, and 200f. The portable terminal devices 200a, 200b, 200c, and 200d are regarded as communication maintenance targets, and the portable terminal devices 200e, and 200f are not regarded as communication maintenance targets.

MFP 100 adjusts the intensity of radio waves which wireless communication unit 122 emits, so that the intensity of radio waves which portable terminal device 200c (a portable terminal device farthest away from MFP 100) which receives the weakest intensity of radio waves receives among portable terminal devices 200a, 200b, 200c, and 200d as communication maintenance targets is at the minimum level at which radio waves of the direct wireless communication with MFP 100 are not interrupted. The range in which the communication is uninterrupted is range RA31.

Since portable terminal device 200e which is not a communication maintenance target among portable terminal devices 200e and 200f is out of range RA31, the intensity of radio waves which portable terminal device 200e receives is at a level at which the direct wireless communication with MFP 100 may be interrupted.

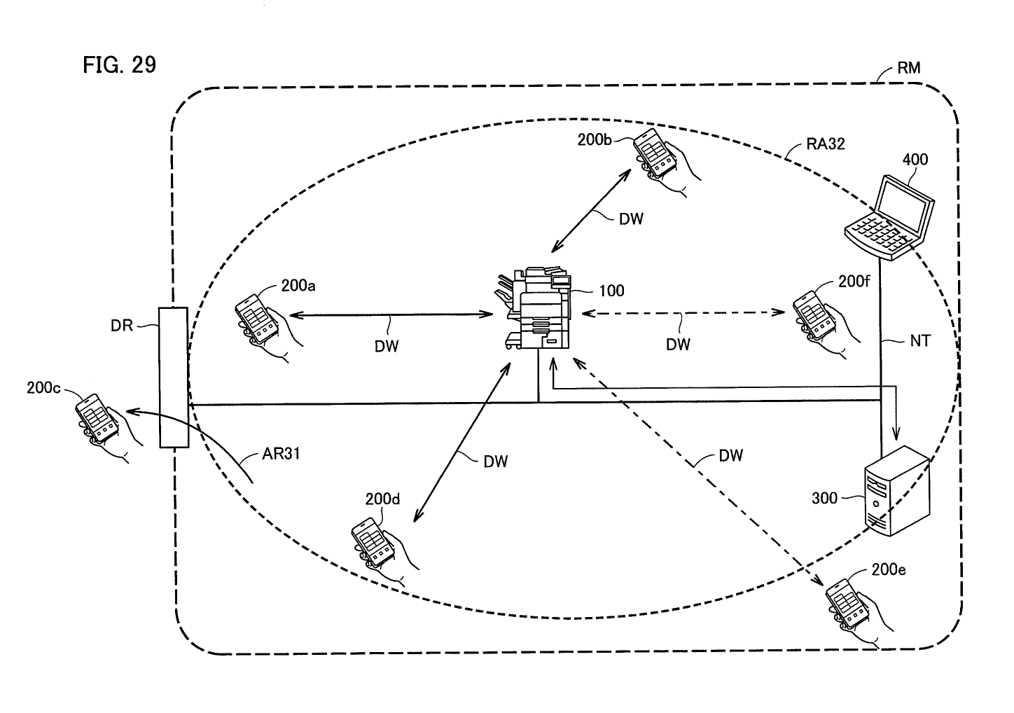

FIG. 29 shows the second figure indicating the behavior of MFP 100, according to the fourth embodiment of this invention.

Referring to FIG. 29, the user C who possesses the portable terminal device 200c performs the operation for leaving the room, and leaves the room RM as shown by arrow AR31. When MFP 100 detects the user C left the room RM based on the information recorded on entering/leaving room table 321, MFP 100 removes portable terminal device 200c from communication maintenance targets. MFP 100 adjusts the intensity of radio waves which wireless communication unit 122 emits, so that the intensity of radio waves which portable terminal device 200d (a portable terminal device farthest away from MFP 100) which receives the weakest intensity of radio waves among portable terminal devices 200a, 200b, and 200d as communication maintenance targets receives is at the minimum level at which radio waves of the direct wireless communication with MFP 100 are not interrupted. Since wireless communication unit 122 does not have beam forming function, MFP 100 adjusts the intensity of radio waves in all directions from the MFP 100 without exception. In consequence, the range in which the communication is uninterrupted is reduced in all directions from the MFP 100 without exception, changing from range RA31 to range RA32. The direct wireless communication DW between MFP 100 and portable terminal device 200c is in the state in which the communication may be interrupted.

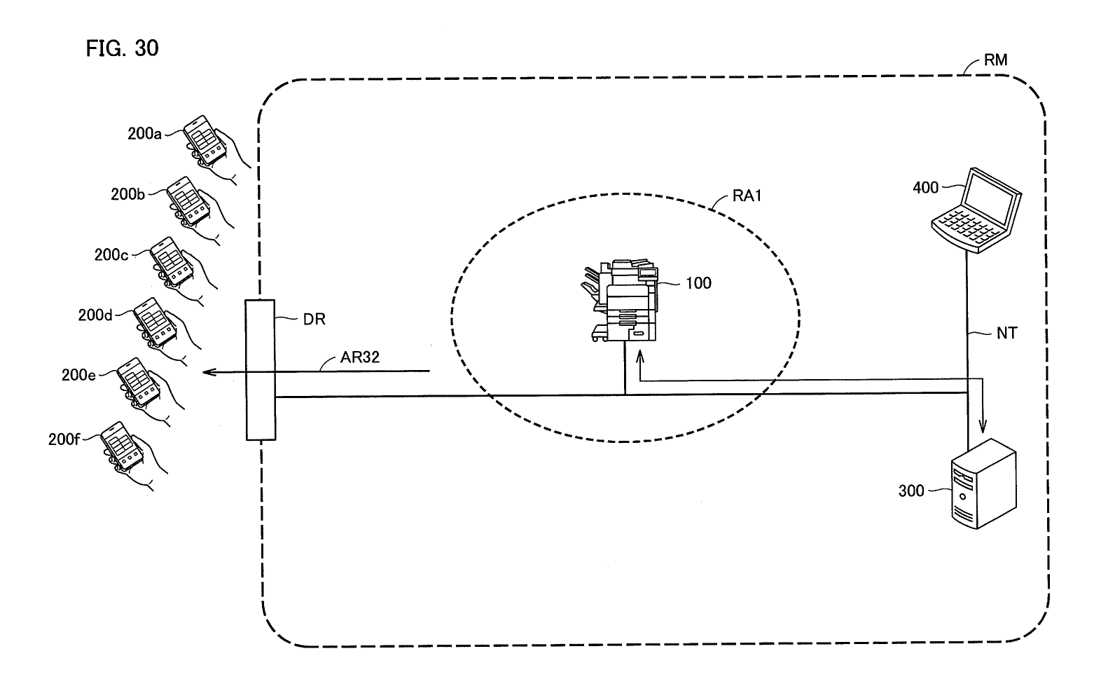

FIG. 30 shows the third figure indicating the behavior of MFP 100, according to the fourth embodiment of this invention.

Referring to FIG. 30, the user A, a user B, a user D, a user E, and a user F who possess the portable terminal devices 200a, 200b, 200d, 200e, and 200f respectively performs the operation for leaving the room, and leave the room RM as shown by arrow AR32. When MFP 100 detects portable terminal devices 200a, 200b, 200d, 200e, and 200f left the room RM, MFP 100 removes portable terminal devices 200a, 200b, and 200d from communication maintenance targets. In consequence, it is a state in which a portable terminal device which is a communication maintenance target does not exist, and MFP 100 sets the intensity of radio waves at the minimum value. The range in which the communication is uninterrupted narrows in all directions from the MFP 100 without exception, changing from range RA32 to range RA1. The direct wireless communication DW between MFP 100 and portable terminal devices 200a, 200b, and 200d is in the state in which the communication may be interrupted.

Since portable terminal devices 200e and 200f are not communication maintenance targets, leaving the room RM of user E and user F does not affect the intensity of radio waves which wireless communication unit 122 emits.

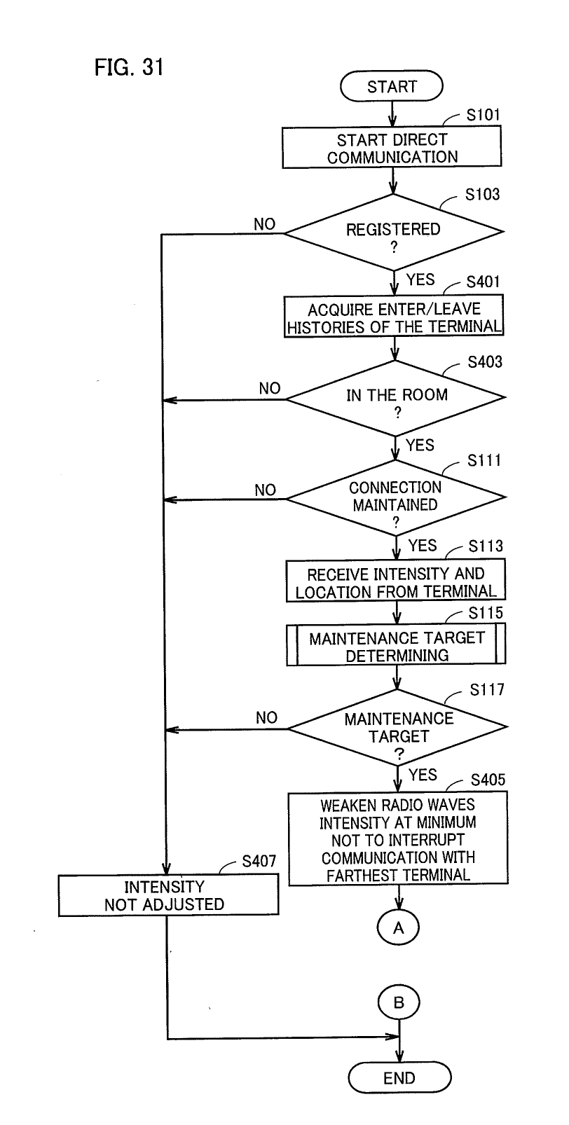

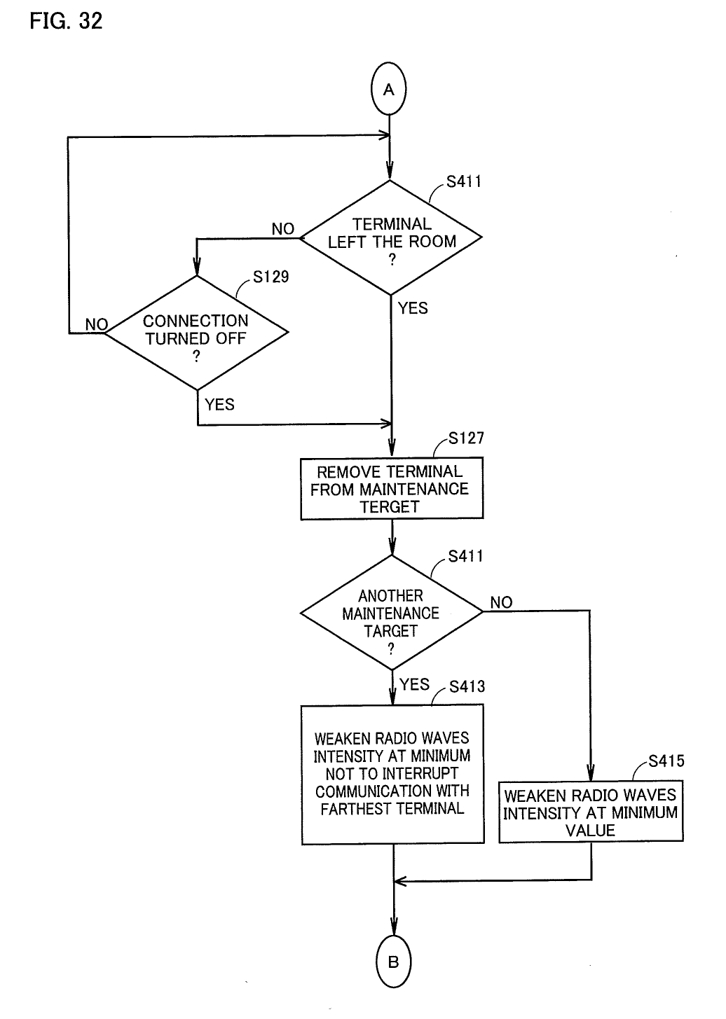

FIGS. 31 and 32 show a flowchart indicating the behavior of MFP 100, according to the fourth embodiment of this invention.

Referring to FIG. 31, at step S103 of the flowchart shown in FIG. 13, when it is determined that the portable terminal device as the communication partner is registered in user information table 121 (YES at S103), CPU 101 acquires the entering/leaving room histories of the user of the portable terminal device as the communication partner (S401), and determines whether the user of the portable terminal device as the communication partner is in the room or not (S403).

At step S403, when it is determined that the user of the portable terminal device as the communication partner is in the room (YES at S403), CPU 101 steps in the process of step S111 in the flowchart shown in FIG. 13.
when it is determined that the portable terminal device as the communication partner is not registered in user information table 121 at step S103 (NO at S103), when it is determined that the user of the portable terminal device as the communication partner is not in the room at step S403 (NO at S403), when it is determined that the direct wireless connection with the portable terminal device as the communication partner is not maintained at step S111 in the flowchart shown in FIG. 13 (NO at S111), or when it is determined that the portable terminal device as the communication partner is not regarded as a communication maintenance target at step S117 in the flowchart shown in FIG. 13 (NO at S117), CPU 101 does not adjust the intensity of radio waves (S407), and terminates the process.

At step S117 in the flowchart shown in FIG. 13, when it is determined that the portable terminal device as the communication partner is regarded as a communication maintenance target (YES at S117), CPU 101 weakens the intensity of radio waves which wireless communication unit 122 emits, so that the intensity of radio waves a portable terminal device farthest away from MFP 100 receives among portable terminal devices which are communication maintenance targets is at the minimum level at which radio waves of direct wireless communication are not interrupted (S405), and steps in the process of step S411 in FIG. 32.

Referring to FIG. 32, at step S411, CPU 101 acquires the entering/leaving room histories of the user of the portable terminal device as the communication partner, and determines whether the user of the portable terminal device as the communication partner left the room or not (S411).

At step S411, when it is determined that the user of the portable terminal device as the communication partner left the room (YES at S411), CPU 101 steps in the process of step S127 in FIG. 14.

At step S411, when it is determined that the user of the portable terminal device as the communication partner does not leave the room (NO at S411), CPU 101 determines whether the communication with the portable terminal device as the communication partner was shut off or not (S129).

At step S129, when it is determined that the communication with the portable terminal device as the communication partner is not shut off (NO at S129), CPU 101 steps in the process of step S411.

At step S129, when it is determined that the communication with the portable terminal device as the communication partner was shut off (YES at S129), CPU 101 steps in the process of step S127 in FIG. 14.

After the portable terminal device as the communication partner was removed from communication maintenance targets at step S127 of the flowchart shown in FIG. 14 (S127), CPU 101 determines whether another portable terminal device as a communication maintenance target exists or not (S411).

At step S411, when it is determined that another portable terminal device as a communication maintenance target exists (YES at S411), CPU 101 weakens the intensity of radio waves which wireless communication unit 122 emits, so that the intensity of radio waves a portable terminal device farthest away from MFP 100 receives among portable terminal devices which are communication maintenance targets is at the minimum level at which radio waves of the direct wireless communication are not interrupted (S413), and terminates the process.

At step S411, when it is determined that another portable terminal device as a communication maintenance target does not exist (NO at S411), CPU 101 weakens the intensity of radio waves at the minimum value (S415), and terminates the process. At step S415, CPU 101 may stop emitting the radio waves.

According to this embodiment, MFP weakens the intensity of radio waves which the wireless communication unit emits in all directions from the MFP without exception, at the minimum level at which radio waves of direct wireless communication with a portable terminal device which is going to be more likely to perform necessary communication with the MFP are not interrupted. Herewith, power consumption of the MFP can be reduced.

Whether a portable terminal device is going to be more likely to perform necessary communication with the MFP or not is determined, based on whether a user of a portable terminal device left the room or not, for example. Therefore, the target of the beam forming can be suitably determined.

### OTHERS

In the first to the fourth embodiments, when MFP 100 receives a predetermined operation (for example, a predetermined key pressing) on operation panel 108, or when the NFC communication was established between a portable terminal device and operation panel 108, MFP 100 may regard portable terminal device 200e or 200f which is not a communication maintenance target as a communication maintenance target, as long as there is connection availability.

In the first to the fourth embodiments, the wireless communication device (an emitter of radio waves) is MFP 100, and the communication apparatus (a receiver of radio waves) is portable terminal device 200. However, the wireless communication device (an emitter of radio waves) may be portable terminal device 200, and the communication apparatus (a receiver of radio waves) may be MFP 100.

In the second or the fourth embodiment, CPU 101 of MFP 100 may restart emitting radio waves by wireless communication unit 122, when a user of any of a plurality of a portable terminal devices 200 enters the room RM after stopping emitting radio waves by wireless communication unit 122.

The above mentioned embodiments can be combined appropriately.

According to this invention, a wireless communication device which can reduce the power consumption and a control program for such the wireless communication device can be provided.

The processes in the above-mentioned embodiments can be performed by software and a hardware circuit. A computer program which executes the processes in the above embodiments can be provided. The program may be provided recorded in recording media of CD-ROMs, flexible disks, hard disks, ROMs, RAMs, memory cards, or the like to users. The program is executed by a computer of a CPU or the like. The program may be downloaded to a device via communication lines like the internet. The processes explained in the above flowcharts and the description are executed by a CPU in line with the program.

Although the present invention has been described and illustrated in detail, it is clearly understood that the same is by way of illustrated and example only and is not to be taken by way limitation, the scope of the present invention being interpreted by terms of the appended claims.

What is claimed is:

1. A wireless communication device capable of executing direct wireless communication with each of a plurality of communication apparatuses, without intermediary equipment, comprising:
an emitting device to emit radio waves for the direct wireless communication,
a determination unit to determine whether a new communication apparatus which is one of the plurality of the communication apparatuses satisfies a specified condition or not, when the direct wireless communication starts with the new communication apparatus,
a target determination unit to regard the new communication apparatus as a communication maintenance target, when the determination unit determined that the new communication apparatus satisfies the specified condition, and
an adjustment unit to weaken intensity of radio waves which the emitting device emits, so that the intensity of radio waves which the emitting device emits and a communication apparatus which is the communication maintenance target receives is within a predetermined range in which the direct wireless communication can be maintained.

2. The wireless communication device according to claim 1, wherein
the adjustment unit does not adjust the intensity of radio waves which the emitting device emits based on information showing the intensity of radio waves a communication apparatus which is not the communication maintenance target received.

3. The wireless communication device according to claim 1, further comprising:
a first information acquire unit to acquire usage histories which are histories of jobs performed on the wireless communication device via the new communication apparatus, wherein
the determination unit determines whether the new communication apparatus satisfies the specified condition or not, based on the usage histories.

4. The wireless communication device according to claim 1, further comprising:
a storage device to store various data, wherein
the determination unit determines whether the communication apparatus satisfies the specified condition or not, based on number of data items which relates to a user of the communication apparatus, stored in the storage device.

5. The wireless communication device according to claim 1, further comprising:
a target removing unit to remove a communication apparatus which is the communication maintenance target from communication maintenance targets, when the communication apparatus as the communication maintenance target exists out of a predetermined communication range.

6. The wireless communication device according to claim 5, further comprising:
a location information acquire unit to acquire information showing a location of a communication apparatus as the communication maintenance target, wherein
the target removing unit removes a communication apparatus as the communication maintenance target from communication maintenance targets, when the location of the information acquired by the location information acquire unit is out of the predetermined communication range.

7. The wireless communication device according to claim 5, wherein
the predetermined communication range is configured by using a location which the wireless communication device is installed as a reference.

8. The wireless communication device according to claim 5, further comprising:
an entering/leaving room information acquire unit to acquire entering and leaving room information for a user of a communication apparatus as the communication maintenance target, on a room in which the wireless communication device is installed, wherein
the target removing unit removes a communication apparatus as the communication maintenance target from communication maintenance targets, when the user of the communication apparatus as the communication maintenance target left the room in which the wireless communication device is installed, based on the entering and leaving room information.

9. The wireless communication device according to claim 5, further comprising:
a minimum adjustment unit to set the intensity of radio waves which the emitting device emits at a minimum, when a communication apparatus as the communication maintenance target does not exist within the predetermined communication range.

10. The wireless communication device according to claim 9, further comprising:
an entering/leaving room information acquire unit to acquire entering and leaving room information for a user of a communication apparatus as the communication maintenance target, on a room in which the wireless communication device is installed, wherein
the minimum adjustment unit sets the intensity of radio waves which the emitting device emits at a minimum value, based on the entering and leaving room information, when all users of communication apparatuses as communication maintenance targets left the room in which the wireless communication device is installed.

11. The wireless communication device according to claim 10, wherein
the minimum adjustment unit stops emitting radio waves by the emitting device, when all users of communication apparatuses as the communication maintenance targets left the room in which the wireless communication device is installed.

12. The wireless communication device according to claim 11, further comprising:
a restart unit to restart emitting radio waves by the emitting device, when a user of any of the plurality of the communication apparatuses enters the room in which the wireless communication device is installed, based on the entering and leaving room information, after stopping emitting radio waves of the emitting device by the minimum adjustment unit.

13. The wireless communication device according to claim 1, wherein
the adjustment unit includes
an intensity acquire unit to acquire information showing the intensity of radio waves emitted by the emitting device and received by a communication apparatus as the communication maintenance target, from the communication apparatus as the communication maintenance target, and
an intensity adjustment unit to weaken the intensity of radio waves the emitting device emits, so that the intensity of radio waves the emitting device emits and the communication apparatus as the communication maintenance target receives is within a predetermined range in which the direct wireless communication can be maintained, based on the information acquired by the intensity acquire unit.

14. The wireless communication device according to claim 1, wherein
the adjustment unit locally strengthens the intensity of radio waves the emitting device emits in a direction in which a communication apparatus as the communication maintenance target exists.

15. The wireless communication device according to claim 1, wherein
the adjustment unit adjusts the intensity of radio waves the emitting device emits in all directions without exception.

16. The wireless communication device according to claim 1, further comprising:
an image forming unit to form an image, based on an execution instruction received from any of the plurality of the communication apparatuses.

17. A non-transitory computer-readable recording medium storing a controlling program for a wireless communication device, wherein
the wireless communication device executes direct wireless communication with each of a plurality of communication apparatuses without intermediary equipment, and
the wireless communication device comprises an emitting device to emit radio waves for the direct wireless communication, wherein
the controlling program causes a computer to execute the steps to:
determine whether a new communication apparatus which is one of the plurality of the communication apparatuses satisfies a specified condition or not, when the direct wireless communication starts with the new communication apparatus,
regard the new communication apparatus as a communication maintenance target, when the determination step determined that the new communication apparatus satisfies the specified condition, and
weaken the intensity of radio waves the emitting device emits, so that an intensity of radio waves the emitting device emits and a communication apparatus which is the communication maintenance target receives is within a predetermined range in which the direct wireless communication can be maintained.
